(19) United States
(12) Patent Application Publication
(10) Pub. No.: US 2015/0242517 A1
(43) Pub. Date: Aug. 27, 2015

(54) IMPACT BASED CONTENT TARGETING

(71) Applicant: Allsay, Inc., Los Angeles, CA (US)

(72) Inventor: Geoff Campbell, Los Angeles, CA (US)

(21) Appl. No.: 14/633,074

(22) Filed: Feb. 26, 2015

Related U.S. Application Data
(60) Provisional application No. 61/945,032, filed on Feb. 26, 2014.

(51) Int. Cl. G06F 17/30

(52) U.S. Cl. CPC G06F 17/30867; G06F 17/3053; G06F 17/30876; G06F 17/30029; G06F 17/30241

(57) ABSTRACT

Methods and systems are disclosed for presenting targeted public content and multimedia coverage content related to public decisions to users that may find them relevant to their lives. In some embodiments, a system according to the present disclosure may analyze public content and multimedia coverage content to identify associations to public decisions and may determine the relevancy of those public decisions to certain users. Public decisions that are relevant to certain users are presented to those users via a display of a computer device. In some embodiments, options are provided that allow users to vote on positions associated with the public decisions, contact key decision makers and influences, and to connect with other users that hold the same or similar positions.

### CROSS-REFERENCE TO RELATED APPLICATIONS AND EFFECTIVE FILING DATE ENTITLEMENT

This application is entitled to the benefit of and/or the right of priority to U.S. Provisional Application No. 61/945,032, entitled “IMPACT BASED CONTENT TARGETING” (Attorney Docket No. 112247-8001.US00), filed Feb. 26, 2014, which is hereby incorporated by reference in its entirety. This application is therefore entitled to a priority date of Feb. 26, 2014

### TECHNICAL FIELD

The present invention generally relates to providing multimedia content, and more particularly to providing targeted multimedia content that relates to matters that impact a user's life.

### BACKGROUND

While more news and other sources of information are available than ever before, people increasingly are having a difficult time staying informed, particularly on matters that have a direct impact on their lives. Most people, almost paradoxically, have two complaints about their news: they don't get enough of it, and they get too much of it. The complaint that they don't get enough of it stems from their feeling that there is news out there that they are missing, and they don't know how to find it. It's a conversation of discovery. The complaint of too much news stems from their challenges in prioritizing what they want to read now, read later, and not read at all. The known techniques for providing relevant multimedia content revolve around allowing a user to choose amongst various categories of content, e.g., business news, science, sports, etc., and providing only those content that belong in one of the chosen categories. Accordingly, the known techniques for providing relevant multimedia content, e.g., news, published articles, etc., to a user are limited in their capabilities and suffers from at least the above constraints and deficiencies.

### BRIEF DESCRIPTION OF DRAWINGS

These and other objects, features and characteristics of the disclosed technology will become more apparent to those skilled in the art from a study of the following detailed description in conjunction with the drawings, all of which form a part of this specification. In the drawings:

FIG. 1 is a block diagram illustrating a multimedia content processing and context matching environment (“context matching environment”) in which the technology can operate in various embodiments;

FIG. 2 is a block diagram illustrating a community driven content processing and matching environment (“community driven content matching environment”) in which the technology can operate in various embodiments;

FIG. 3 is a block diagram illustrating a user action driven content processing and matching environment (“user action driven content matching environment”) in which the technology can operate in various embodiments;

FIG. 4 is a block diagram illustrating a voting recommendation environment in which the technology can operate in various embodiments;

FIG. 5 is a block diagram of a computer system as may be used to implement features of some embodiments of the disclosed technology;

FIG. 6 provides an illustrative example of a login page of a social networking environment;

FIG. 7 provides an illustrative example of an intro page of the social networking environment;

FIG. 8 provides an illustrative example of a personal context page of the social networking environment which lists the various categories into which the user's life has been partitioned into and the identified public content within each of those categories;

FIG. 9 provides an illustrative example of a personal context page of the social networking environment which lists the various categories into which the user's life has been partitioned into and the identified public content within each of those categories;

FIG. 9a provides an illustrative example of an integrated page of the social networking environment including both personal profiler questions and relevant content;

FIG. 10 provides an illustrative example of the display of a relevant article provided to the user under one of their personal categories within the social networking environment;

FIG. 11 provides an illustrative example of one such discussion forum/thread initiated by the user on a provided article within the social networking environment;

FIG. 12 provides an illustrative example of the return to the display of a relevant article, provided to the user within the social networking environment, when returning from the discussion forum/thread;

FIG. 13 provides an illustrative example of a displayed article, provided to the user within the social networking environment 600, when the user initiates actions to follow the public content associated with the displayed article;

FIG. 14 provides an illustrative example of a user interface that can be provided to the user to enable them to decide whether to make their vote (i.e. an expressed opinion) on the displayed article public or not;

FIG. 15 provides an illustrative example of a means for providing the user with information about one or more other users of the social networking environment who have expressed similar opinion on the displayed article and a means for allowing the user to create a group/club to pursue activities or other shared interests with those users sharing similar view points as the user;

FIG. 16 provides an illustrative example of the content displayed, provided to the user within the social networking environment, when the user returns from utilizing the means for allowing the user to create a group/club to pursue activities or other shared interests with those users sharing similar view points as the user;

FIG. 17 provides an illustrative example of the personal context page of the social networking environment, which includes the list of the categories into which the user's life has been partitioned into, the identified public content within each of those categories and any votes (i.e. expressed opinion) by the user with respect to the identified public content;

FIG. 18 provides an illustrative example on an article identified for the user under the user's “KIDS” category, where the article relates to local schools the user's kids could likely be attending and be impacted by any public actions discussed in the article;

FIG. 19 provides an illustrative example of how the user can initiate a discussion forum/thread with other users of the social networking environment who may have expressed an opinion on the subject;

FIG. 20 provides an illustrative example of the displayed article provided to the user, within the social networking environment, when returning from initiating the discussion forum/thread;

FIG. 21 provides an illustrative example of how the user can perform a search for interested political actions and other categories within the social networking environment;

FIG. 22 provides an illustrative example of how the search results are provided to the user in response to a search performed by the user within the social networking environment;

FIG. 23 provides an illustrative example of a new activity summary that can be provided to the user of the social networking environment;

FIG. 24 provides an illustrative example of a summarized new activity summary that can be provided to the user of the social networking environment;

FIG. 25 provides an illustrative example of the personal category list provided to the user, within the social networking environment, when returning from reviewing the summarized new activity summary;

FIG. 26 provides an illustrative example of the additional personal categories that are provided to the user within the social networking environment;

FIG. 27 provides an illustrative example of how the relevant political content provided to the user within the social networking environment can be improved;

FIG. 28 provides an illustrative example of a displayed article, provided to the user within the social networking environment, when the user clicks on an article provided within their “JOBS & INCOME” personal category;

FIG. 29 provides an illustrative example of an updated new activity summary that now provides updates related to the user's spouse (upon identifying the spouse by the user) in the social networking environment;

FIG. 30 provides an illustrative example of an alert provided to the user of the social networking environment through any of their computing devices, e.g., smart phones, tablets, etc.; and

FIG. 31 provides an illustrative example of a summary of a political action relevant to the user.

### DETAILED DESCRIPTION

Hereinafter, descriptions will be provided on embodiments of the disclosed technology with reference to the drawings. References in this description to “an embodiment”, “one embodiment”, or the like, mean that the particular feature, function, or characteristic being described is included in at least one embodiment of the present invention. Occurrences of such phrases in this specification do not necessarily all refer to the same embodiment, nor are they necessarily mutually exclusive.

Technology is disclosed for providing targeted multimedia content to a user, particularly content relating to matters (also referred to herein as “decisions”) that impact a user's life (“the disclosed technology”). The disclosed technology combines various unstructured multimedia content (e.g., news articles, blogs, published articles, etc.) with associated public decisions and presents them to the user in a personal context. Public “decisions” as related to context may be all decisions, including but not limited to decisions by governments (e.g., government actions such as proposed legislation, ordinances, propositions, proposals, changes to operations, etc.), legal decisions (e.g., court opinions, etc.) decisions by business entities (e.g. a merger or acquisition, product or service offering, business strategy and practices, employment matters, regulatory issues, etc.), entertainment related decisions (e.g., movie studio releases and casting decisions, promotions, etc.), and decisions by sports organizations (e.g. player signings, roster moves, etc.). It is worth noting that “public decisions” do not necessarily refer to decisions made by the public, but instead refer to decisions that may have an impact on the everyday lives of members of the public. For example, a members of the public indirectly have a say in proposed legislation through their vote for representatives, but may not have any say in a privately traded company's acquisition decisions. Nevertheless, such decisions may impact the public and can therefore be referred to as public decisions. In some embodiments, a “public decision” is identified as a decision that both 1) affects a member of the public, and 2) is of a type that a member of the public would want to be included in (even if they do not actually have a say or a vote). The disclosed technology further enables the users to assess the impact of the various public actions on their lives and helps them constructively engage with the community, e.g., by voting in sample polls, providing feedback to interested entities, providing commentary on the public actions, etc., where such community includes the users' online social network, local community forums, etc.

According to some embodiments, the disclosed technology utilizes a given user's profile (e.g., social media profiles, social open graph, user provided personal information data, user actions, etc.) to understand what is relevant to the given user. For example, a user's recent purchase of a road bike, participation in a local bike club, reading articles related to biking, social connections to other users who have expressed interest in biking, etc., can be utilized by the disclosed technology to infer that biking is of interest to the user. The disclosed technology further utilizes media coverage and other sources of information (e.g., published articles, etc.) of the various public actions to understand the scope of the public actions and possible impact of such actions on the given user. Other embodiments may gradually accumulate data related to a use via targeted questions presented to the use in order to understand what is relevant to the user.

According to some embodiments, the disclosed technology may allow the user to actively select the public decisions that are most important to them as favorites. Selected favorite decisions may be included as part of a community index presented to the user to allow the user to track favorite decisions. Each decision identified as important by a user may be tracked for progress. For example, a user may select a decision on whether a favorite sports team will move to another city. The selected decision may appear in a community index presented to the user via the disclosed technologies. In some embodiments the community index may include a percentage of users that share the opinion of the user, comments from other users including but not limited to allies (discussed later), a news feed of media related to the decision, and comments and opinions from key decision makers (e.g. the team owners or league executives in this example). In some embodiments, a community index value may be calculated that incorporates all the above data into a single value or score that represents the progress towards a decision in line with the user's opinion. In some embodiments, the community index value may be a scaled value (e.g. 0-100), a percentage, may be expressed as a symbol (e.g. thumbs up or down), or a color, etc.

The disclosed technology presents those public decisions and their associated media coverage which impact the given user, enabling the given user to have access to relevant multimedia content. Further, the disclosed technology analyzes the given user's activity history, including actions such as following public content (e.g., news regarding legislations, propositions, sports, entertainment, etc.), engaging with public content (e.g., posting comments on the followed content, clicking on like/dislike buttons within the content, time spent per content, etc.), to recommend how the given may vote in various matters that best protects their interest. The voting recommendations can be for any activity that could directly or indirectly help the given user best protect their interest. For example, the voting recommendations can be provided for any upcoming elections, including candidates, propositions, initiatives, referenda and other questions being posed to the public during an election.

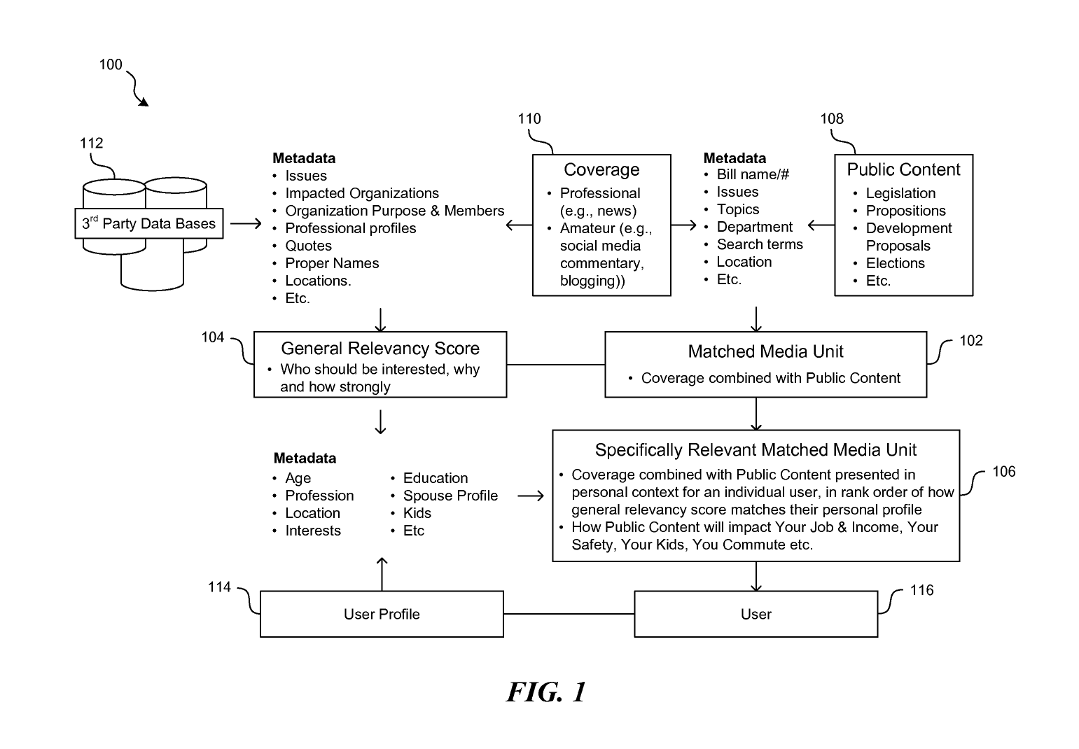

Several embodiments of the disclosed technology are described in more detail in reference to the Figures. Turning now to Figures, FIG. 1 is a block diagram illustrating a multimedia content processing and context matching environment 100 (“context matching environment”) in which the technology can operate in various embodiments. The context matching environment 100 includes a public content database 108, a multimedia coverage content database 110 (“coverage database”), a third party databases 112, a user profile database 114, a general relevancy scoring module 104 (“general relevancy score” or “scoring module”), a matched media generation unit 102 (“matched media unit”), and a specifically relevant matched media unit 106 (“specific media unit”).

In some embodiments, the public content database 108 includes content related to various public decisions being pursued by various entities (e.g., public entities such as governments, semi-public entities affiliated with the various government entities, e.g., local schools, local governments, local development agencies, zoning enactment/enforcement agencies, state governments, state energy commission overseeing utilities, EPA, federal government, etc, and private entities such as consumer product/service providers, entertainment providers, sports organizations, etc. The various public decisions being tracked and stored in the database 108 could include legislations, propositions, development proposals, elections, policy changes, court opinions, etc.

The content being stored in the database 108 may include digital copies of content related to the public decisions. For example, content stored may include, but is not limited to, copies of proposed bills, propositions, development proposals, evidence provided in support of the various bills and proposals, election candidate policy statements, court opinions, biographies of key decision makers, business earnings reports, athlete statistics, etc. In embodiments, the database 108 can further include a database index to parse and manage the metadata associated with the stored content. For example, a proposed bill can be parsed to identify the bill number, issues as highlighted under the appropriate section on the bill, topics, departments concerned, potential search terms, location impacted by the bill, etc.

Content stored in database 108 may also include information on all key decision makers associated with the decision. Such information may be gathered from other public content sources or multimedia coverage. For example an article regarding an upcoming piece of new legislation may trigger the formation of a public decision. The article is likely to include information regarding the key decision makers, for example, the legislators involved. Information on the key decision makers relevant to a particular user may depend on that user's geographic location. For example, if a user is located in San Francisco, the key decision makers on a bill before Congress may include both the senators from California as well as the representative for the user's district in San Francisco.

It is important to note that the key decision makers will not always be limited to individuals with executive authority or a vote (such as a CEO or congress person). While those person are certainly important, a system in accordance with the present teachings will also seek information on other people that may hold influence. For example, in the above scenario of a bill before Congress, the list of key decision makers may be extended to include key members of the media (e.g. a journalist that has written extensively on the subject of the bill and enjoys a national audience), politicians and leaders that have influence with particular members of congress (e.g. a religious leader or political ally), academic leaders (e.g. a professor that has studied and published on the subject of the bill extensively), and any other people that may have an influential effect. This group of key players may be referred to collectively as an “ecosystem of influence.” Discovery of these key players may be accomplished through the use of matching algorithms applied to various content. For example, a matching algorithm may match a professors publication to an article by a journalist in which a congress person is mentioned. By matching information (for example based on metadata) a system in accordance with the present teachings may automatically determine that the professor, the journalist, and the congress person are all key decision makers to be included in the ecosystem of influence. Information on these key decision makers (including contact information and/or publicly available biographical information (e.g. gathered from a third-party database) may be presented to a user in order to facilitate that user's interaction with the decision.

In embodiments, the coverage database 110 stores content including multimedia coverage content relating to the various public actions. The multimedia content may include, but is not limited to, audio, video, image, and text based content. Further, the sources of the multimedia coverage content could include news media, blogs, social media commentary, published articles, impact studies, opinion pieces, etc. In embodiments, the database 110 can further include a database index to parse and manage the metadata associated with the stored content. For example, a news article on a proposed bill can be parsed to identify the proposed bill's bill number, source of the news article, quotes from the sponsor of the bill, the identity of the sponsor of the bill, quotes from other source about the bill, the name and any given title of the other sources, etc. Accordingly, through this process, a system using the disclosed teachings can automatically identify public decisions from public content and multimedia coverage content and parse any relevant information related to that decision from the public content and multimedia coverage content.

In embodiments, the matched media unit 102 can analyze the public content stored in database 108 and multimedia coverage content 110 stored in database 110 (along with their respective metadata) to match the public content with the appropriate multimedia coverage content 110. In some embodiments, the multimedia coverage content 110 analyzes the metadata associated with the public content and the multimedia coverage content to identify appropriate match between the contents. For example, in a simple match, a bill number associated with the public content and the coverage content could be matched to identify the related content. The content matching could be further improved by analyzing the various combinations of metadata associated with the content and ranking the combinations based on an intra-ranking of the various metadata. For example, a match of content-coverage based on a bill's number should be higher than an issue based match, where the bill number based match is very specific (pointing to possible specific discussion of the bill's content) while the issue based match is a more general form of matching the bill's content to coverage. As discussed later, the matched public content-multimedia coverage could be provided to users based on the relevancy of the matched public content-multimedia coverage to the users. In embodiments, the third party databases 112 store content including information that helps improves the context and relevancy of the multimedia coverage content. The stored content could include information associated with various organizations, their affiliated members, their positions, issues relevant to the organizations' members, their positions, issues relevant to a particular demography, poll results on profiles of various experts in their respective fields, positions of various experts on various topics, list of authorities and their respective impact on a given subject (e.g., the supreme court or a supreme court justice's opinion can have a greater impact on a subject, such as gun control, immigration law, etc., compared to a local congressman on the subject), etc. The content from the third party databases 112 can be utilized to provide improved context and relevancy for the multimedia coverage content stored in the coverage database 110.

In embodiments, the general relevancy scoring module 104 utilizes the multimedia coverage content stored in the content database 110 and the context data stored in the third party databases 112 to determine the relevancy of the multimedia coverage content to various demography. In embodiments, the scoring module 104 generates a score on a scale to indicate the strength of relevancy of a given content to a given demography. In embodiments, the scoring module can utilize predefined groups of demography by subject. For example, the demography groups for immigration related coverage could include the non-resident immigrant group, permanent-resident immigrant group, undocumented immigrant group, citizen group, organized labor group, farming community, high-tech community, etc.

In embodiments, the scoring module 104 can analyze the metadata associated with the multimedia coverage content (e.g., issues, impacted organizations, etc.) and the information stored in the third party databases 112 (e.g., the significance of the covered issue to a given demography, the authority of the people quoted in the content, the scope of impact of the covered issue, etc.) to determine the relevancy of the covered issue to various demography (where demography is defined by the issue covered). In embodiments, the scoring module 104 further determines a score on a scale to indicate the strength of interest. In embodiments, the scoring module 104 includes metadata in association with the score to signify a rationale for the score (e.g., “gun control”, “abortion rights”, etc., to express a rationale).

For example, using the information from the third party databases 112 and the content database 110, the scoring module 104 can analyze a multimedia coverage content and determine the news article is from NY Times®, a highly respected source of news, and that the news article is regarding a recent healthcare bill. By performing a metadata analysis, the scoring module 104 can further determine that the article specifically concerns the healthcare bill's impact on abortion rights.

Further, using the profiles stored in the third party databases 112, the scoring module 104 can analyze quotes from the article relating to the rights and identify that the person the quote is from is a sitting supreme court justice. Based on the source of the content, the issues covered and the authority cited, the scoring module 104 can rate the article as highly relevant to the public in general and to women in particular.

In embodiments, the specific media unit 106 utilizes the relevancy score from scoring module 104, the user profile 114 information of users and the matched public content-multimedia coverage to provide users with relevant content in a personal context, showing how the public content impacts the various aspects of their lives. In embodiments, the personal context could include the users' job and income, safety, kids, commute, etc. In embodiments, the specific media unit 106 utilizes the general relevancy score of a given multimedia coverage to a given demography to identify those multimedia coverage and their matched public content to be presented to the users who belong to the given demography.

In embodiments, the specific media unit 106 presents the identified public content-multimedia coverage to the users belonging to the given demography in a personal context. In embodiments, the identified public content-multimedia coverage can be ranked in their respective category according their general relevancy score. For instance, in the above discussed example, the news article in NY Times®, concerning the impact of a healthcare bill on abortion rights, was determined to be highly relevant to women.

Utilizing user profile information in the user profile database 114, the specific media unit 106 can identify users 116 who are women. Here, the user profile information could include the age, gender, education, profession, interests, spouse profile, kids, location, etc. In embodiments, the user profile information could be gathered from social media profiles maintained by the users, e.g., profiles in Facebook®, LinkedIn®, etc. Further, the specific media unit 106 can identify the public content associated with the healthcare bill that is subject of the NY Times® article from the matched media unit 102. The healthcare bill, its associated content and the news articles can be presented to women users under the context of their health and safety.

According to some embodiments, a decision matching/scoring module (e.g. scoring module 104) may apply an algorithm that includes a number of selection passes along with various randomizing and weighting factors.

In an example non-limiting embodiment, the algorithm makes three top level passes, one pass each for local, state, and national level geographic areas. As part of each top level pass, four additional pass iterations are made, one for each of a question mapping priority level. Priority levels may be defined as 3, 2, 1, and 0 (unspecified). In other words, for a given user, this example algorithm will perform up to twelve independent match iterations in the following order:

1. Local Matches—Priority: 3

2. Local Matches—Priority: 2

3. Local Matches—Priority: 1

4. Local Matches—Priority: 0 (unspecified)

5. State Matches—Priority: 3

6. State Matches—Priority: 2

7. State Matches—Priority: 1

8. State Matches—Priority: 0

9. National Matches—Priority: 3

10. National Matches—Priority: 2

11. National Matches—Priority: 1

12. National Matches—Priority: 0

Within each of the above defined iterations, the algorithm queries a database (e.g. public content stored in database 108 and multimedia coverage content 110 stored in database 110) for decisions that meet a threshold criteria. The following are some example criteria that may be employed:
The decision is mapped to a profile question that a user has answered “yes” to
The question mapping has a priority value that matches the current iteration
The decision's primary geographical target matches a geographical area for the user at the specific iteration (e.g. local vs. state).
The decision is new and not already queued for the user
The user has not interacted with the decision in the past (e.g. by electing to skip)

The queries are sent to the relevant database (e.g. database 108 or 110) resulting in up to 50 matches. If the resulting set of matches includes more than one decision, a weighted randomizer may be used.

A weighted randomizer may be used to pull decisions from an eligible set using weighted pseudo-random process. In this example algorithm, weights are assigned based on factors such as trending and temporal proximity (i.e. how recent the identified decision is). Both trending and temporal factors are applied as percentages. For example, a trending factor may be influenced by the number of users voting on the decision. The trending factor of a decision may increment each time a vote is received. Additionally the trending factor may be based both on numbers of votes received, but also the rate at which votes are received. For example a decision with 100 votes in the last 24 hours may have a higher trending factor than a decision with 100 votes in the last 24 days. Similarly, if a decision has trending factor of 1% based on a received vote total of 10, that decision may be 10% more likely to be matched than a decision that has no votes. Further, a decision with 1000 votes will receive a 1000% boost, meaning that it is 10 time more likely to be matched. A temporal factor may be based on a period of time elapsed since the decision or content associated with the decision was submitted. The temporal factor may be applied as more of a penalty. In one example, a percentage point may be added for every day since the decision was submitted or identified. In other words, a decision that is 40 days old may have a temporal factor of 30%, meaning that the decision is 30% less likely to be matched. The temporal factor may have a cap up to 99% such that a decision that is 99 days old is weighted the same as a decision that is 365 days old.

In some cases this calculation may not be sufficiently granular. e.g., with a 1% temporal factor a decision that is 30 days old may be only 30% less likely to be picked than a brand new decision, which may not be sufficient to reliably push newer decisions to the front. But simply increasing the temporal factor, say to 10% per day, may not achieve the desired results. This is because any decisions 10 days or older will then receive the maximum penalty of 99% (using the default cap), thereby removing any distinction between decisions that are 10 days and 1000 days old. Therefore, to deal such situations, one or more geometric multipliers may be applied to the trending and/or temporal factors. The goal is to increase the appropriate factor value at a geometric rate for each increment (each vote or each day).

The following table demonstrates the effect of a geometrical multiplier of 2.0 on a temporal factor of 1% and the geometric multiplier is 2.0:

| Age (in days) | Calculation | Actual Penalty |
|---|---|---|
| 0 | 0 | 0 |
| 1 | 1% | 1% |
| 2 | 1% * 2.0 | 2% |
| 3 | 2% * 2.0 | 4% |
| 4 | 4% * 2.0 | 8% |
| 5 | 8% * 2.0 | 16% |
| 6 | 16% * 2.0 | 32% |
| n | 2.0\hat{ }(n-1) | 2.0\hat{ }(n-1) |

As shown, the penalty associated with the temporal factor can increase rapidly with a larger geometric multiplier. Accordingly, to achieve more effective results, the multiplier is preferably set to between 1.0 and 1.2.

After trending and temporal factors have been applied to each decision in the original set, a decision is picked at random from the set, taking into consideration the weighted factors. According to some embodiments, the randomizing and weighting process only affects section from a current iteration set. In other words, local decisions may not be compared to state or national decisions. Similarly, a local decision with an priority of 2 will only be compared to other local decisions with a priority of 2 and not to local decisions with a priority of 1 or 3.

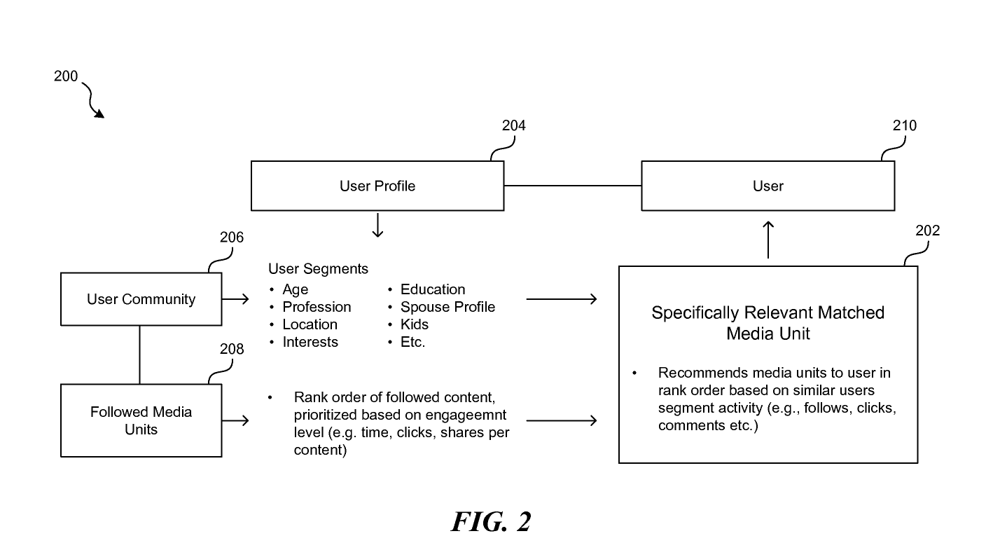

Turning now to FIG. 2, FIG. 2 is a block diagram illustrating a community driven content processing and matching environment 200 (“community driven content matching environment”) in which the technology can operate in various embodiments. The community driven content matching environment 200 includes a specifically relevant matched media unit 202 (“specific media unit”), a user profile database 204, a user community database 206, and a community followed media units 208 (“followed content database”).

In embodiments, the user community database 206 maintains information regarding various user communities/demography. The stored information includes the various criteria by which each such user community is delineated from the others. The criteria includes age, profession, education, location, kids, interests, family, etc. In embodiments, the followed content database 208 includes information regarding the various content being followed by the users belonging to the various user communities and the level of engagement of the users with the followed content as measured by factors such as time spent, contents clicked, shares per content, etc.

In embodiments, the specific media unit 202 utilizes the content from the user profile database 204, the user community database 206 and the followed content database 208 to identify content relevant to a user community that a given user belongs to and present the identified content to the given user. The specific media unit 202 utilizes the user profile information of the given user from the user profile database 204 to match and identify the user community the given user belongs to. The specific media unit 202 further utilizes the identified user community and the followed content database 208 to identify the content most relevant to the user community to which the given user belongs.

In embodiments, the specific media unit 202 utilizes the identified content and presents it to the given user in an order based on the level of engagement exhibited by the other users of the user community. For example, if the given user has expressed interest in biking and a community of users who have all expressed interest in biking have spent a significant time on an article, the specific media unit 202 can present the article to the given user given the high likelihood that the article is related to biking and therefore, likely appeal to the given user. In embodiments, the specific media unit 202 can further perform a content analysis (e.g., using metadata matching, etc.) on an identified article to further confirm the relevance of the article before presenting it to the user.

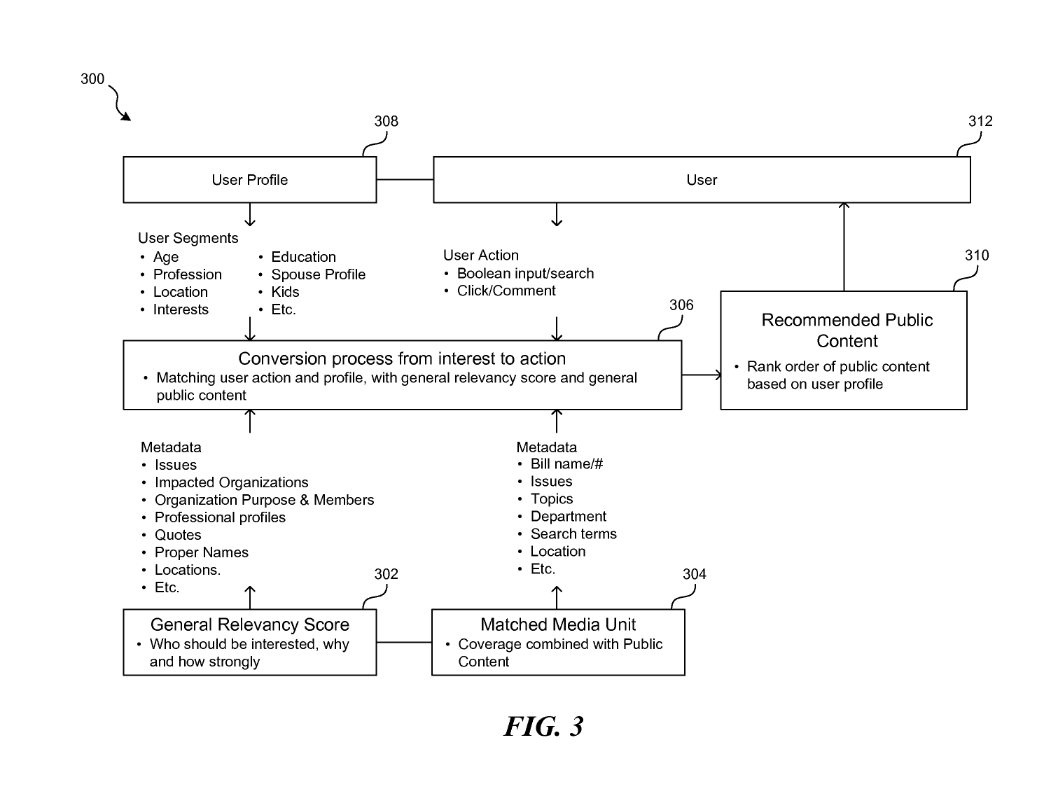

Turning now to FIG. 3, FIG. 3 is a block diagram illustrating a user action driven content processing and matching environment 300 (“user action driven content matching environment”) in which the technology can operate in various embodiments. The user action driven content matching environment 300 includes a general relevancy scoring unit 302 (“scoring module”), matched media unit 304, an interest to action conversion module 306 (“conversion module”), a user profile database 308, and a content recommendation module 310.

In embodiments, the conversion module 306 utilizes a given user's profile, the given user's specific actions, the general relevancy score of various multimedia coverage content from scoring module 302 and the matched public action-content coverage information from the matched media unit 304 to determine the public actions and its associated content coverage that are likely to appeal to the given user. In embodiments, similar to the specific media unit 106, the conversion module 306 utilizes the a given user's profile 308, the general relevancy score of various multimedia coverage content from scoring module 302 and the matched public action-content coverage information from the matched media unit 304 to determine the public actions and its associated content coverage that are likely to appeal to users of a given demography the given user belongs to.

In embodiments, the conversion module 306 further utilizes the history of user actions to further filter those identified public actions and associated coverage that appeal to users of the demography the given user belongs to. The recorded user actions of the given user, utilized by the conversion module 306, can include searches performed by the given user, articles clicked, articles liked/disliked, comments posted, articles shared, length of time spent on a given article, etc. In embodiments, the conversion module 306 utilizes the recent search terms of the user to further filter the identified content to those related to the search terms. In embodiments, the conversion module 306 can utilize a combination of the various user actions to filter the identified content.

In embodiments, the content recommendation module 310 utilizes the user profile information 308 and the content filtered by the conversion module 306 to order and present the filtered content to the user. In embodiments, the content recommendation module 310 utilizes the user profile information 308 to identify interests that are relatively more important to the user than another interest of the user. For instance, for a user with kids who has extensively researched about local public school and who has also extensively researched about hiking trails, the content recommendation module 310 will prioritize public content and associated coverage impacting local public schools over any public content and associated coverage impacting hiking trail availability.

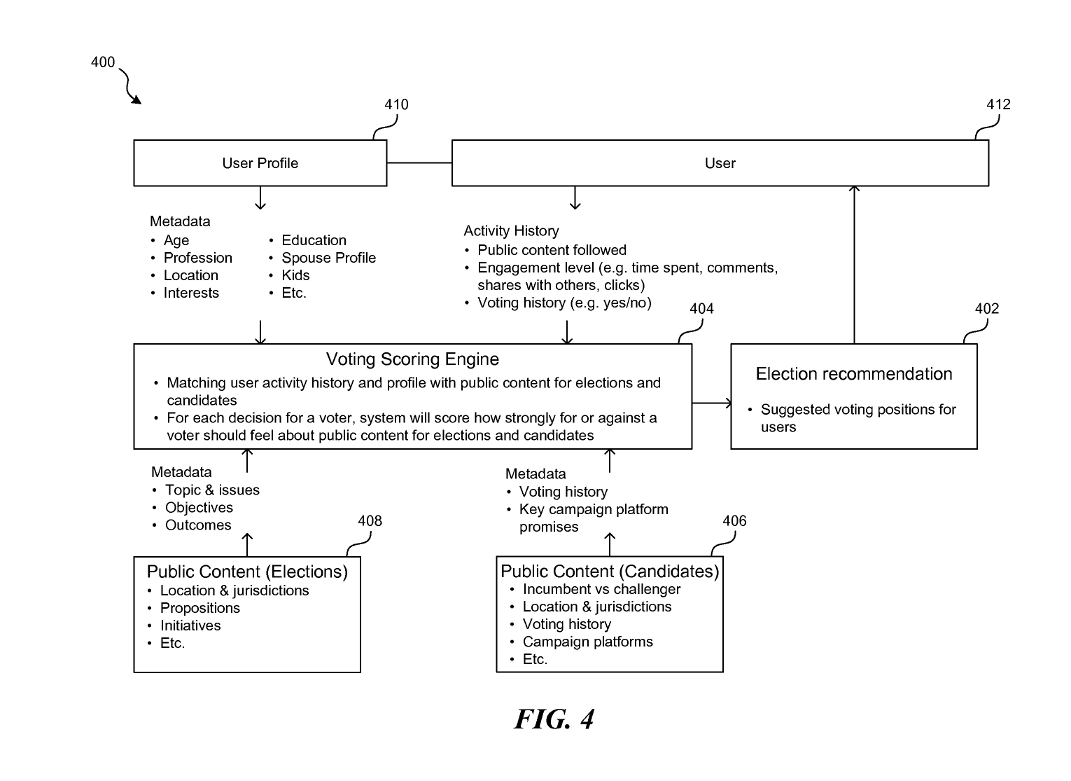

Turning now to FIG. 4, FIG. 4 is a block diagram illustrating a voting recommendation environment 400 in which the technology can operate in various embodiments. The voting recommendation environment 400 includes an election recommendation module 402, a voting scoring engine 404, a candidate focused public content database 406, an election focused public content database 408, and a user profile database 410.

In embodiments, the voting scoring engine 404 utilizes the user activity/action history 412, the user profile information 410, the candidate focused public content 406, and the election focused public content 408 to determine the public content for elections and candidates that are most relevant to a given user. In embodiments, the election focused public content database 408 maintains content related to propositions, initiatives, development proposals, judiciary elections, local body elections, state elections, national elections, etc. In embodiments, the election focused public content database 408 maintains metadata associated with the stored content, such as topics, issues, objectives, potential outcomes, pros and cons, etc.

In embodiments, the voting scoring engine 404 utilizes the activity history of the given user and their personal context to determine public content relating to the upcoming elections, propositions, etc., which have a direct impact on the user's life. In embodiments, the voting scoring engine 404 can perform a metadata matching of the public content, such as topics and issues covered in the content, its objective, its suggested potential outcome, etc., to determine the public content relevant to the given user.

In the above discussed example, if a user has searched extensively for news relating to local public schools and the user profile further indicates that the user has kids, the voting scoring engine 404 will identify public content related to elections, propositions, etc., which include topics and issues, relating to local public schools with a direct impact on the user. In embodiments, the voting scoring engine 404 further utilizes the objectives, gathered pros and cons, potential outcomes, etc., to determine a score on a scale indicating how strongly for or against the user should feel about the identified public content related to elections, propositions, etc. based on the impact of their advocated position on the user.

In embodiments, the voting scoring engine 404 utilizes the activity history of the given user and their personal context to determine public content relating to candidates, such as their voting history, campaign platform, their position as incumbent or challenger, jurisdiction, etc., who can potentially make decisions that have a direct impact on the user's life. In embodiments, the voting scoring engine 404 can perform a metadata matching of the public content relating to the candidates, such as voting history, key campaign platform promises, etc., to determine the public content relating to candidates that the given user will consider most important when evaluating the candidate.

In the above discussed example, if a user has searched extensively for news relating to local public schools and the user profile further indicates that the user has kids, the voting scoring engine 404 will identify public content relating to candidates to the local school district, etc., such as campaign promises relating to the schools, voting history in previous local school district elections, etc., to enable the user to identify the best candidate to protect their interests. In embodiments, the voting scoring engine 404 further utilizes the objectives, gathered pros and cons, potential outcomes, etc., to determine a score on a scale indicating how strongly for or against the user should feel about the identified public content related to candidate based on the impact of their advocated position on the user.

In embodiments, the election recommendation module 402 utilizes the score determined by the voting scoring engine 404 of the various identified public content relating to elections and candidates to provide the given user 412 with suggestions of which way to vote in the elections. For instance, if a public content associated with a proposition is scored low indicating that the user should feel against the position of the content, the election recommendation module 402 utilizes the objective of the public content to provide a voting recommendation. In this instance, the election recommendation module 402 would provide the voting recommend that best opposes the stated objective in the public content associated with a proposition.

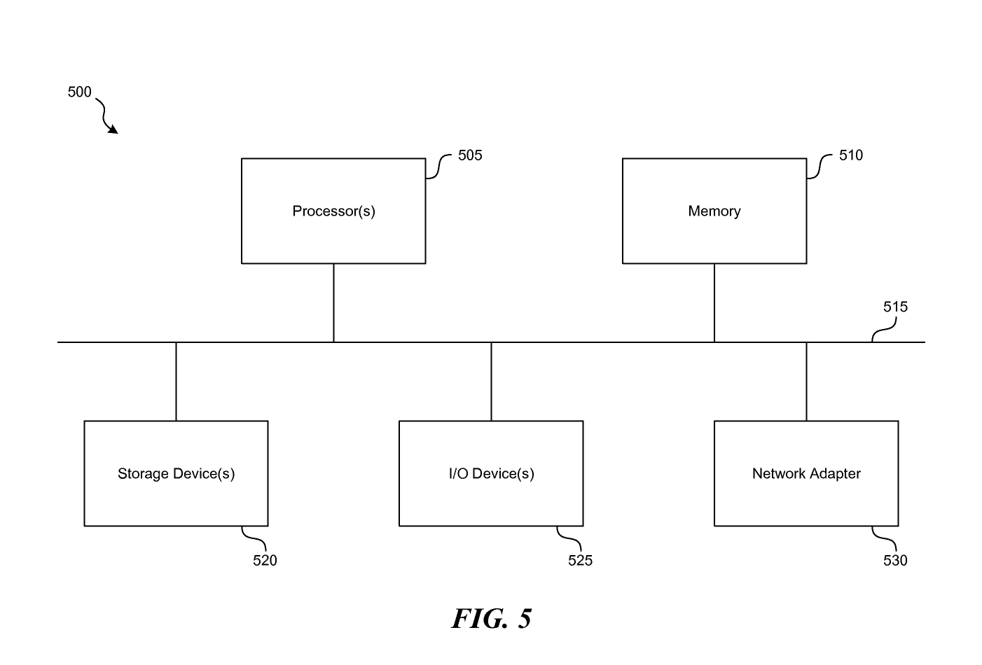

Turning now to FIG. 5, FIG. 5 is a block diagram of a computer system as may be used to implement features of some embodiments of the disclosed technology. The computing system 500 may include one or more central processing units (“processors”) 505, memory 510, input/output devices 525 (e.g., keyboard and pointing devices, display devices), storage devices 520 (e.g., disk drives), and network adapters 530 (e.g., network interfaces) that are connected to an interconnect 515.

The interconnect 515 is illustrated as an abstraction that represents any one or more separate physical buses, point to point connections, or both connected by appropriate bridges, adapters, or controllers. The interconnect 515, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The memory 510 and storage devices 520 are computer-readable storage media that may store instructions that implement at least portions of the described technology. In addition, the data structures and message structures may be stored or transmitted via a data transmission medium, such as a signal on a communications link. Various communications links may be used, such as the Internet, a local area network, a wide area network, or a point-to-point dial-up connection. Thus, computer readable media can include computer-readable storage media (e.g., “non transitory” media) and computer-readable transmission media.

The instructions stored in memory 510 can be implemented as software and/or firmware to program the processor(s) 505 to carry out actions described above. In some embodiments, such software or firmware may be initially provided to the processing system 500 by downloading it from a remote system through the computing system 500 (e.g., via network adapter 530). The technology introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

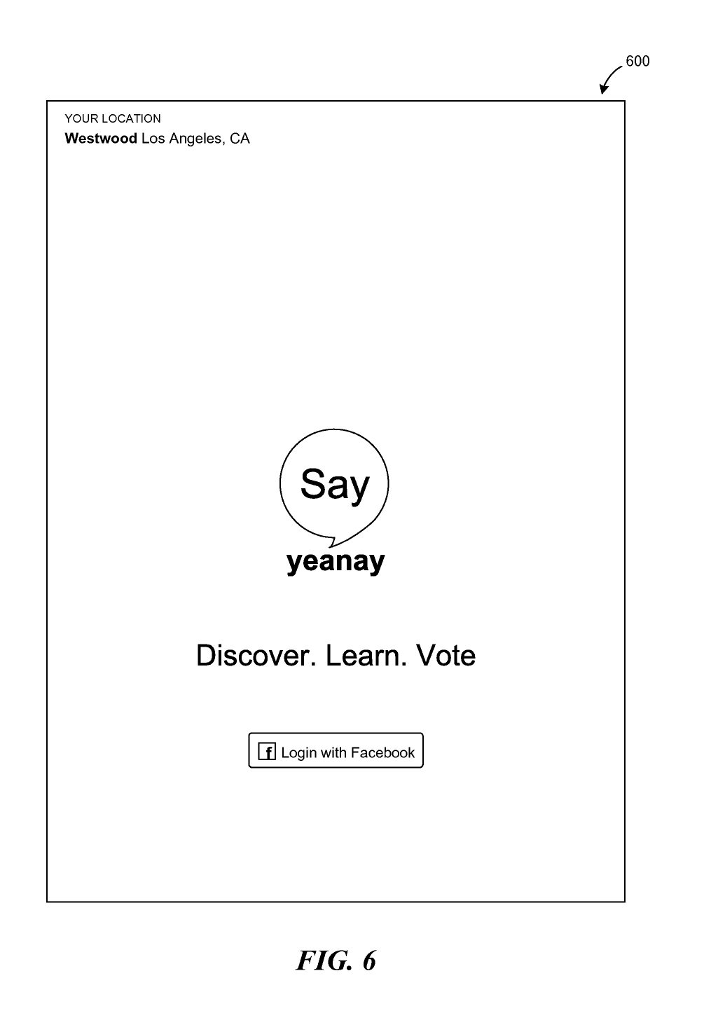

Turning now to FIGS. 6-31, FIGS. 6-31 illustrate a social networking environment 600 in which the technology can operate in various embodiments. FIG. 6 provides an illustrative example of a login page of a social networking environment 600. In embodiments, a user can login into the social networking environment 600 using the login of another social network the user belongs to. The user profile information from the other social network of the user can be utilized in the social networking environment 600 to which the disclosed technology operates. For example, Yeanay® is a social networking environment 600 the user belongs to and Facebook® can be another social network the user also belongs to. By logging into Yeanay® using Facebook® credentials, Yeanay® can sync the user profile information between the two social networks.

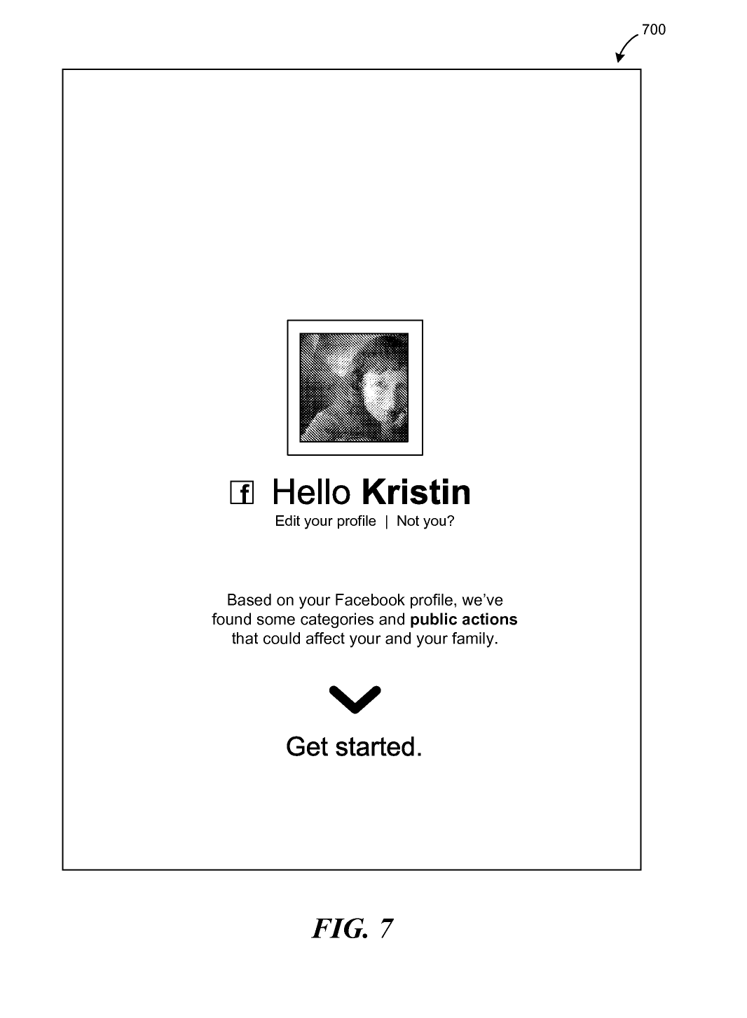

FIG. 7 provides an illustrative example of an intro page 700 of the social networking environment 600. In embodiments, the intro page 700 informs the user that the social networking environment 600 has determined a personal context for the user and identified relevant public content to be provided to the user within that determined personal context.

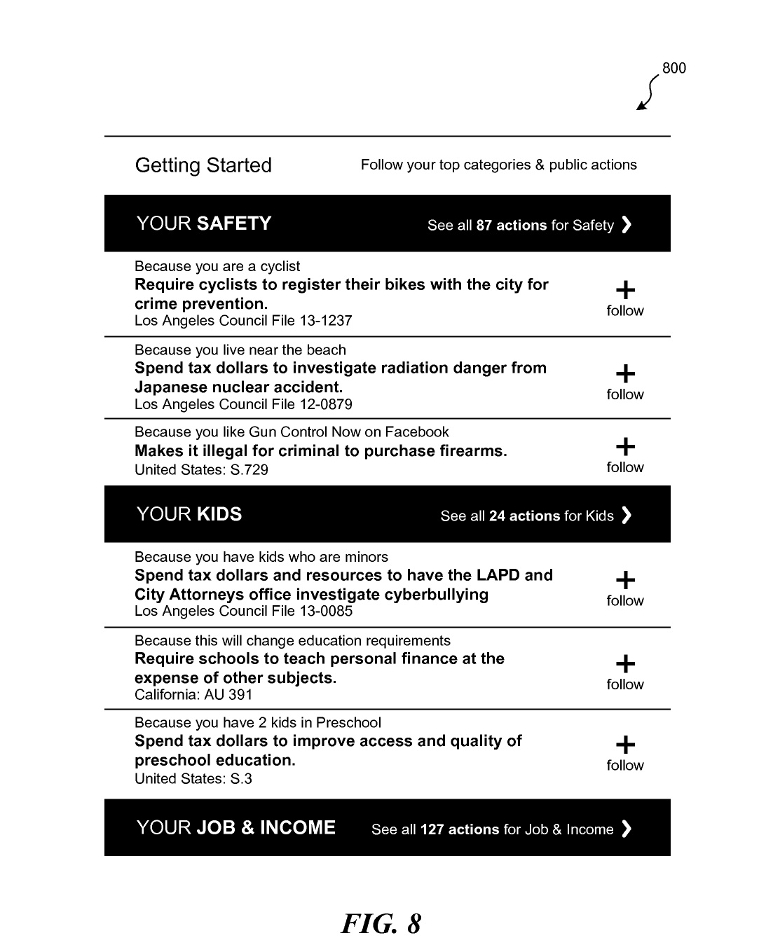

FIG. 8 provides an illustrative example of a personal context page 800 of the social networking environment 600 which lists the various categories into which the user's life has been partitioned into and the identified public content within each of those categories. In embodiments, the identified public content within each category is ranked based on a determined general relevancy score of the public content to the user.

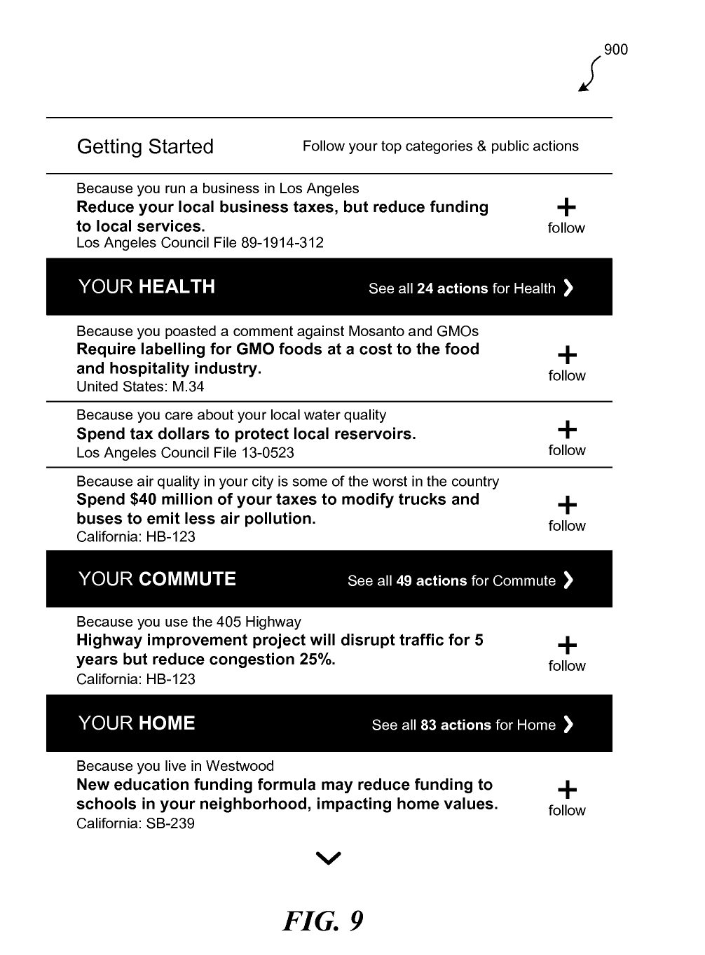

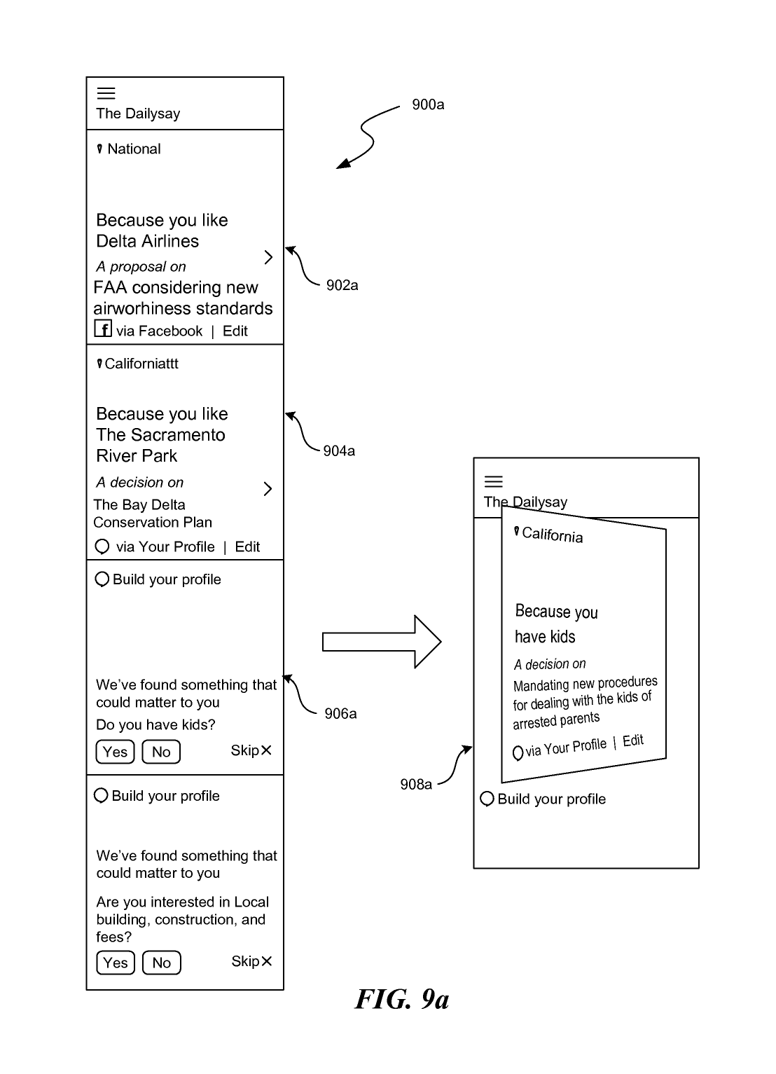

FIG. 9 provides an illustrative example of a personal context page 900 of the social networking environment 600 which lists the various categories into which the user's life has been partitioned into and the identified public content within each of those categories. In embodiments, the personal context page 900 is utilized to highlight some categories while other categories are greyed out. The categories highlighted are those for which the user's personal information was sufficient to analyze and provide relevant public content. The other greyed out categories are those for which the user's personal information was sufficient to create a category but not sufficient to analyze and provide relevant public content.

FIG. 9a show an example interface 900a that illustrates an alternative mode of gathering personal context information in streamlined fashion on a daily basis. As shown in FIG. 9a, when a user accesses the social networking environment (e.g. environment 600) they may be presented with a list of decisions, for example decisions 902a and 904a. The presented decisions 902a and 904a may be based on already gathered information from the user or may be selected at random if this is the first time the user has accessed the environment. The example interface 900a shown in FIG. 9a is configured for presentation on a display device of a mobile device such as a smart phone. Accordingly the user may access additional decisions by scrolling (up/down and/or left/right). As shown in FIG. 9, a user may scroll through presented decisions 902a and 904a and then be presented with a targeted profile question 906a. Targeted profile questions are inserted at random or according to a preset schedule or routine and are configured to improve the decision matches presented to the user. In this example, targeted profiler question 906a asks the user if they have kids. The user is presented with options to answer in the affirmative or negative. If they answer in the negative, that information is included in their profile and the question disappears. If the user answers affirmatively, the information is included in their profile and they are presented with a decision 908a related to the users response to the targeted profile question. Here because the user answers that they have kids, they are presented with a decision on mandating new procedures for dealing with the kids of arrested parents.

Information about user preferences may also be gathered through the form of feedback on presented decisions. For example, decision 902a in FIG. 9a relates to new standards to be considered by the FAA. This decision was presented to the user because past activity indicated a user interest in Delta Airlines®. If the user selects and interacts with decision 902a, they may be provided with an option to “like” or “dislike” the decision. A system in accordance with the present teachings would take this feedback information to inform decision match/selection algorithms for that particular user. Accordingly, if the user dislikes the decision related to the FAA standards because they do not care about those standards, the algorithms may be adjusted to bypass decisions involving the FAA.

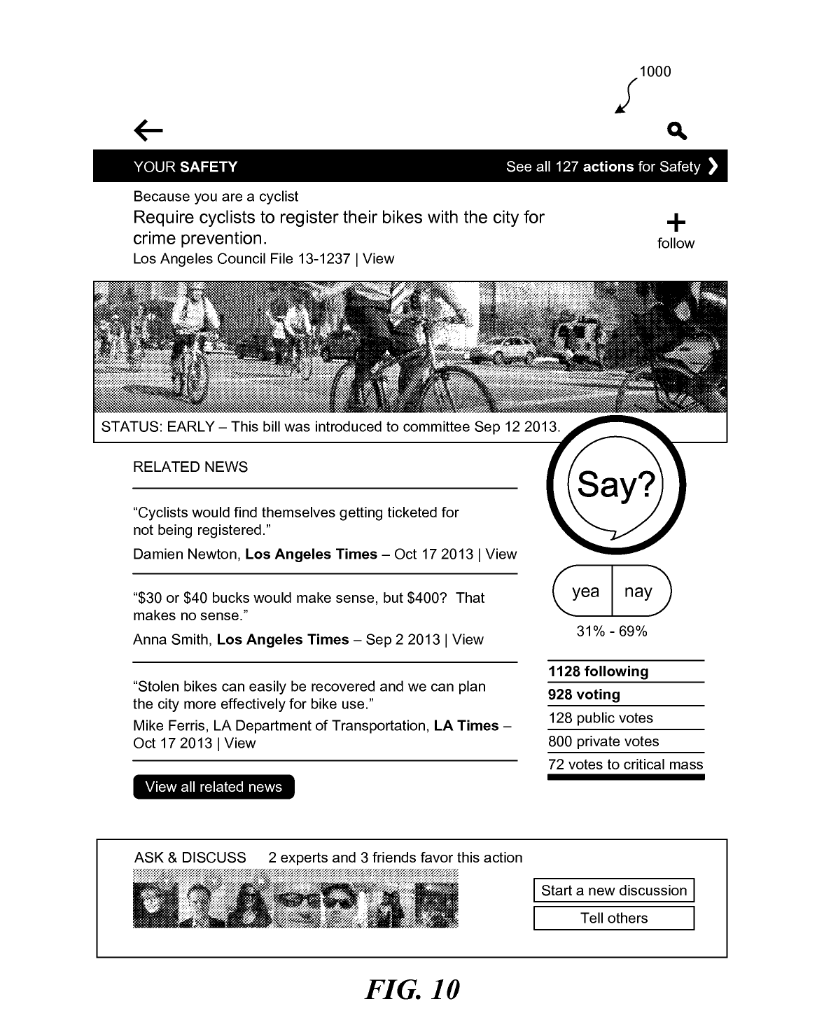

FIG. 10 provides an illustrative example of the display of a relevant article 1000 provided to the user under one of their personal categories within the social networking environment 600. When the user clicks on one the provided articles, in embodiments, the disclosed technology displays the article 1000 to the user along with other related news/articles. In embodiments, the disclosed technology also allows the user to register their opinion (e.g., by voting) on a position expressed in the provided article. The disclosed technology allows the opinions of other users of the social networking environment 600 to be combined and displayed to the user as various metrics.

According to some embodiments the list of relevant decisions or articles presented to a user may depend solely on the geographic location of that user. For example, if a user is located in San Francisco, the user may be presented with a list of the top decisions and/or articles relevant to that geographic location despite the individual interests of the user as indicated by their profile information.

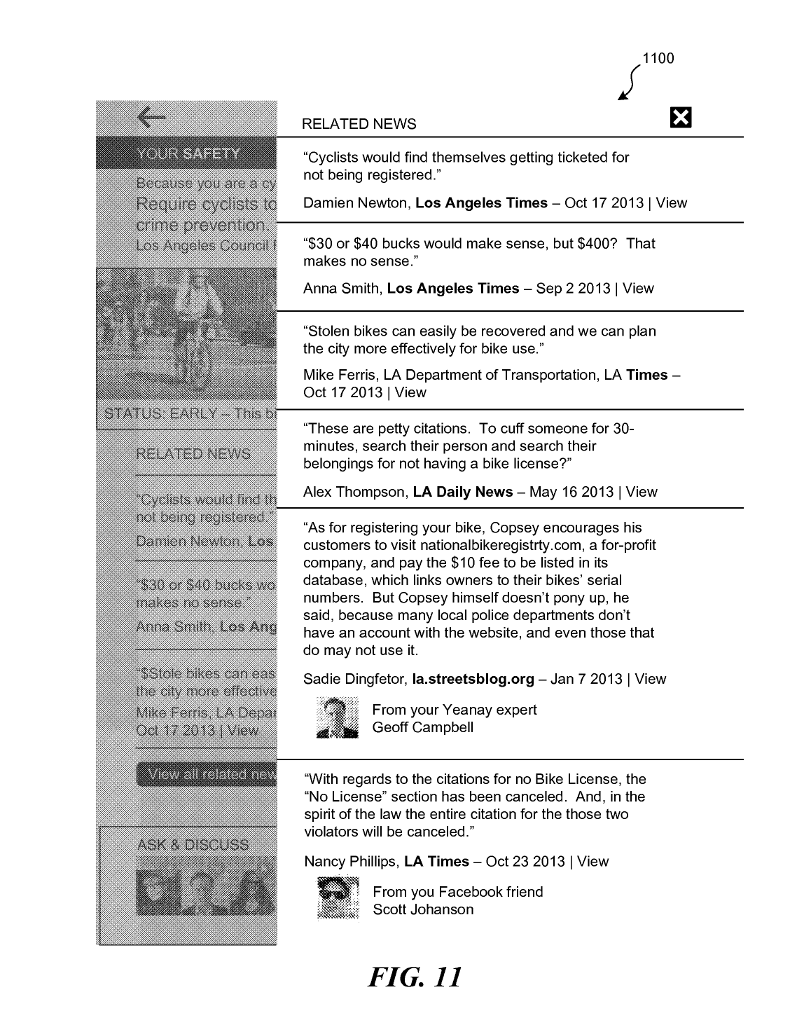

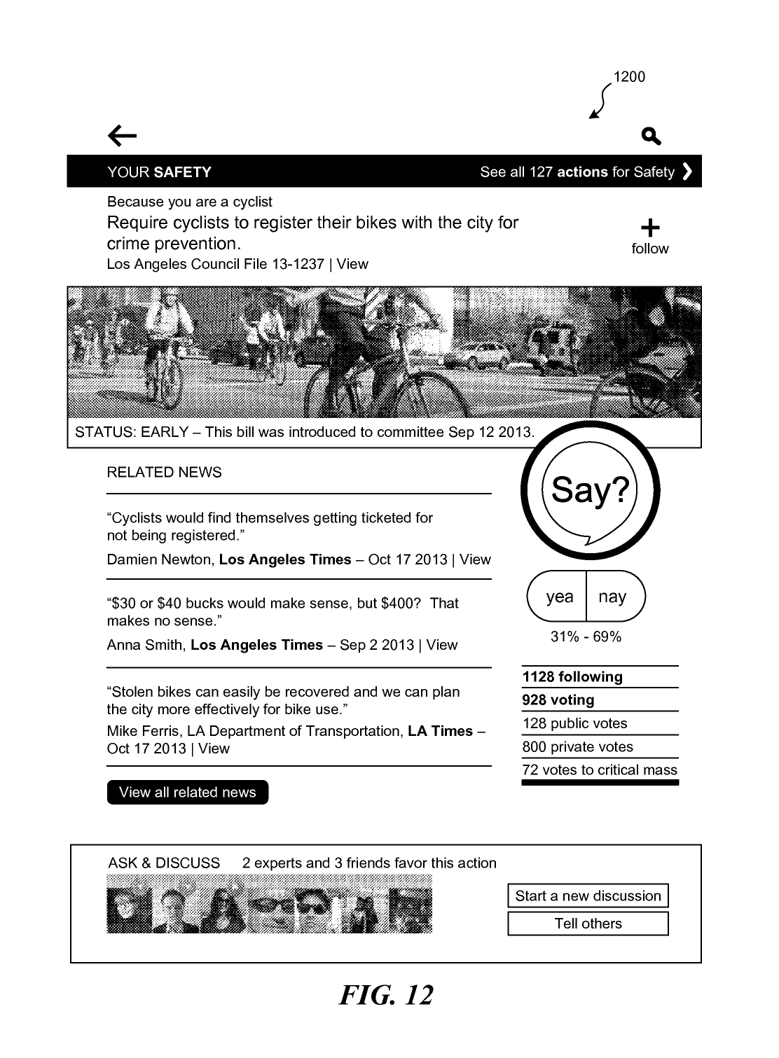

Further, the disclosed technology may provide a list of other users of the social networking environment 600 who have expressed their opinion on the subject. However, as previously discussed this may be configured such that users remain hidden from each other unless they express similar positions on a given decision. In embodiments, the disclosed technology allows the user to form a group from those listed users to initiate a discussion forum/thread. FIG. 11 provides an illustrative example of one such discussion forum/thread 1100 initiated by the user on a provided article within the social networking environment 600. FIG. 12 provides an illustrative example of the return to the display of a relevant article 1200, 1000, provided to the user within the social networking environment 600, when returning from the discussion forum/thread 1100.

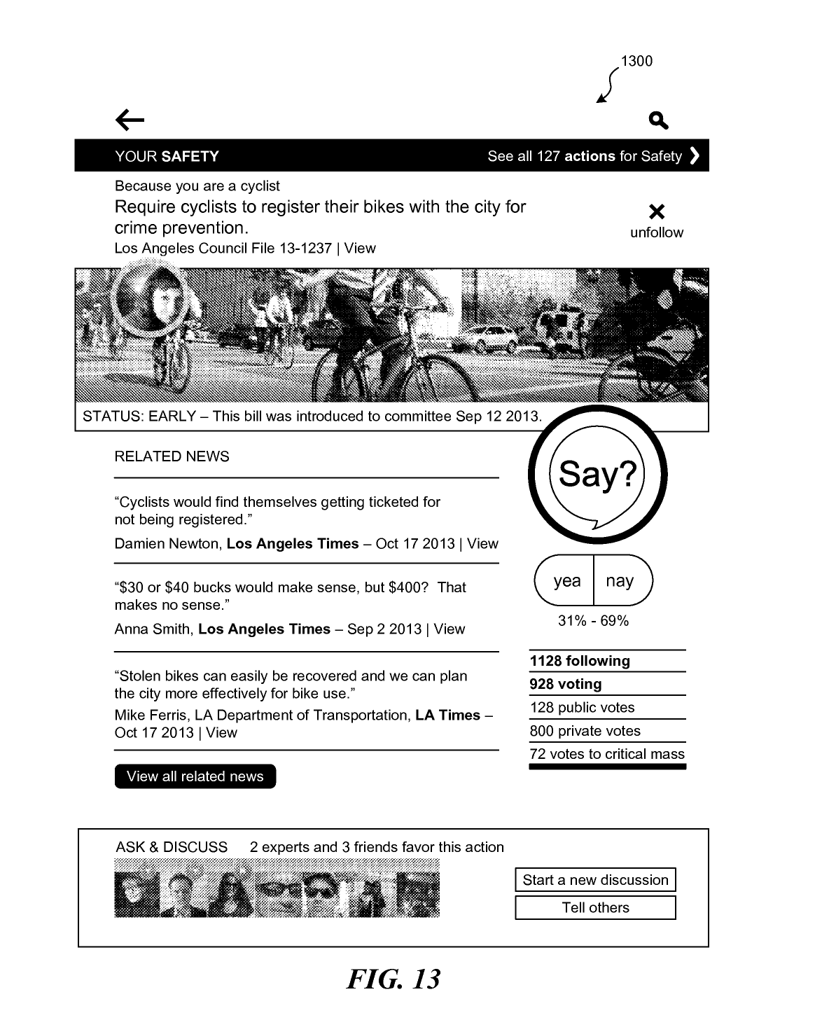

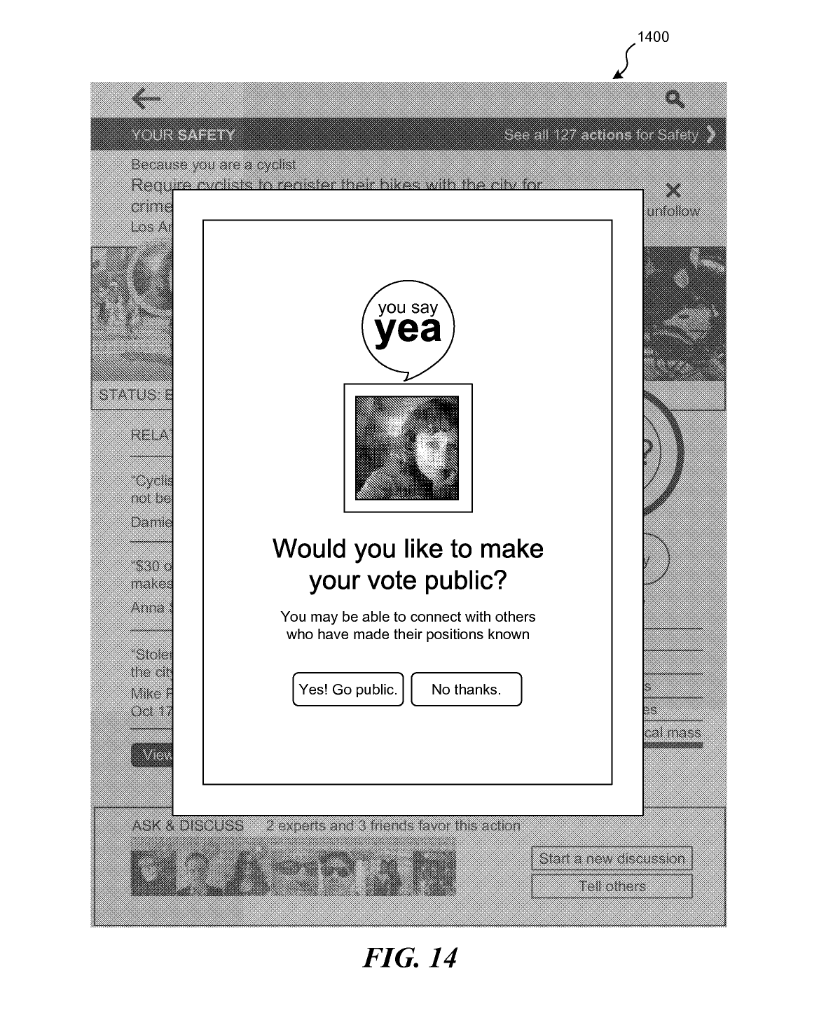

FIG. 13 provides an illustrative example of a displayed article 1300, provided to the user within the social networking environment 600, when the user initiates actions to follow the public content associated with the displayed article 1300. FIG. 14 provides an illustrative example of a user interface 1400 that can be provided to the user to enable them to decide whether to make their vote (i.e. an expressed opinion) on the displayed article public or not.

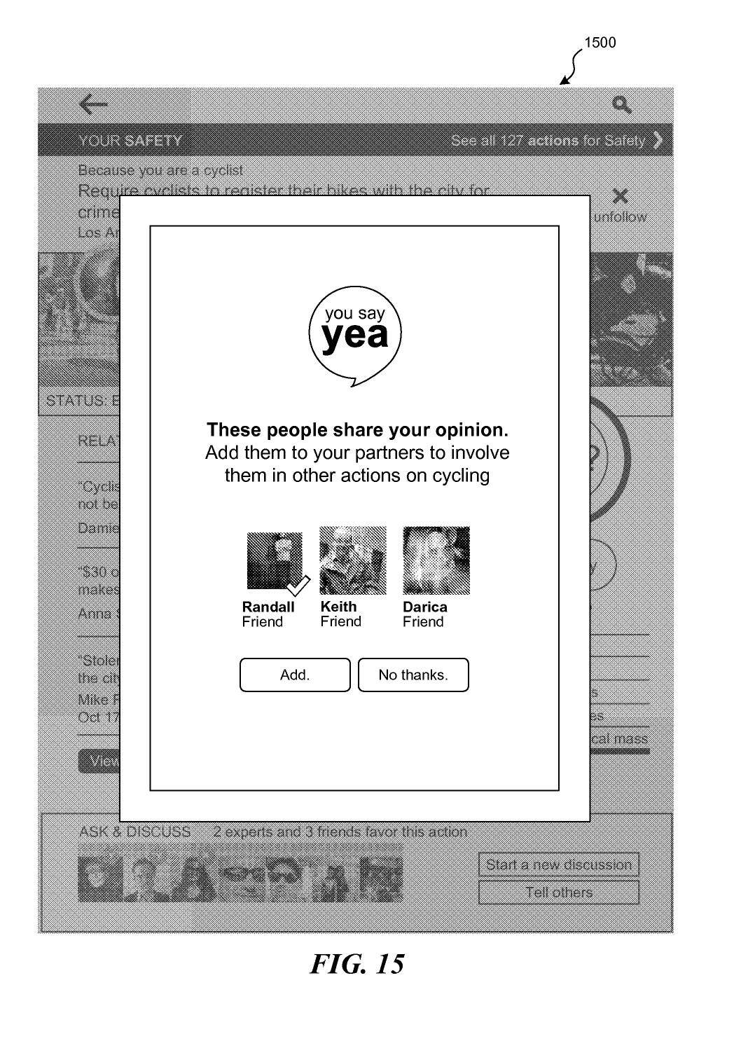

FIG. 15 provides an illustrative example of a means 1500 for providing the user with information about one or more other users of the social networking environment 600 who have expressed similar opinion on the displayed article and a means for allowing the user to create a group/club to pursue activities or other shared interests with those users sharing similar view points as the user. Such users with similar opinions may be referred to as allies. In certain embodiments, social connections made between allies are restricted to relevant decision or issue. In other words, if users A and B present similar positions on a decision related to gun control, they may be presented options to be allies on the decision. The connection may allow for additional functionality such as chatting, exchange of information, scheduling events, lobbying decision makers, etc. However the connection (along with any information) will be restricted to the gun control issue. Although allies, user A would not be able to view user B's activity that is unrelated to the gun control decision, for example support for position on a decision related to local building ordinances. In some embodiments, input provided by allies may be incorporated to curate the experience of a user. For example if users A and B become allies on decision related to environmental protection, user A may input comments, suggest decisions, provide reactions, or otherwise input data related to environmental protection. Input by user A may be prioritized for presentation to user B because they are allies on the decision. In other words, who a user allies with and what those allies do in relation to the alignment may impact algorithms (for example algorithm(s) applied by a scoring module 104) used to recommend and present public decisions to the user.

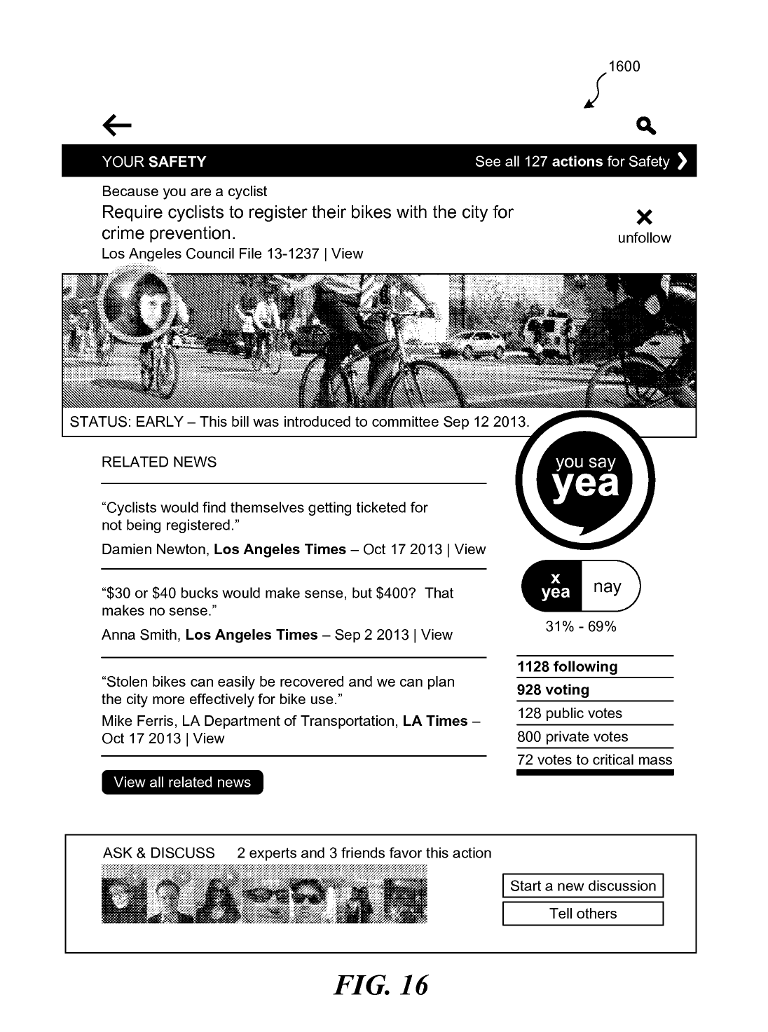

FIG. 16 provides an illustrative example of the content displayed (i.e. displaying the relevant article 1600, 1200), provided to the user within the social networking environment 600, when the user returns from utilizing the means 1500 for allowing the user to create a group/club to pursue activities or other shared interests with those users sharing similar view points as the user.

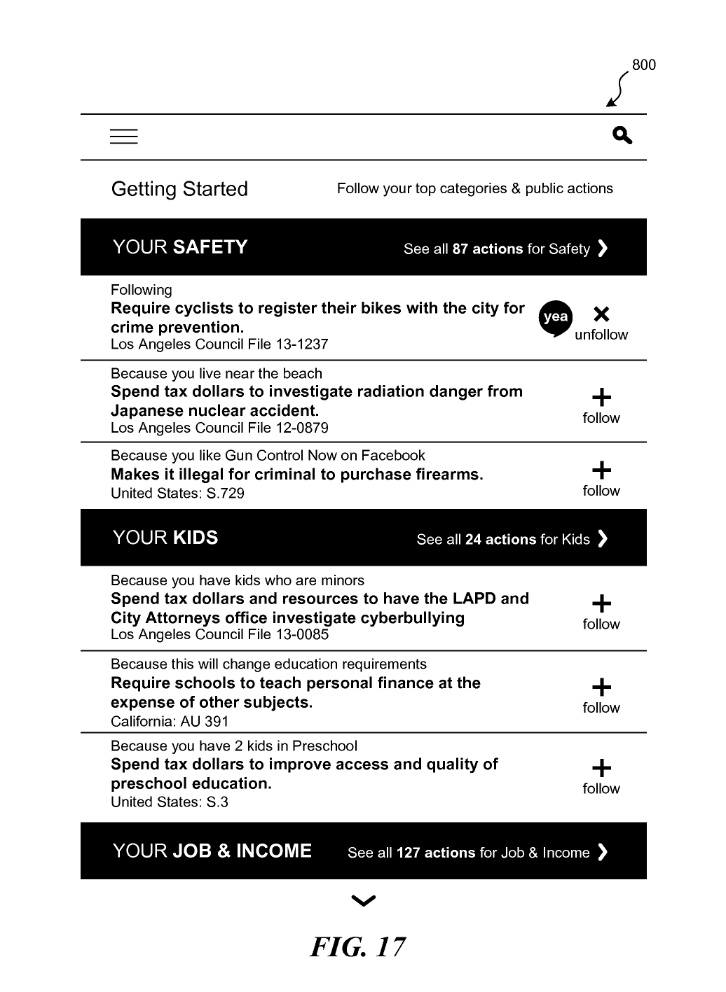

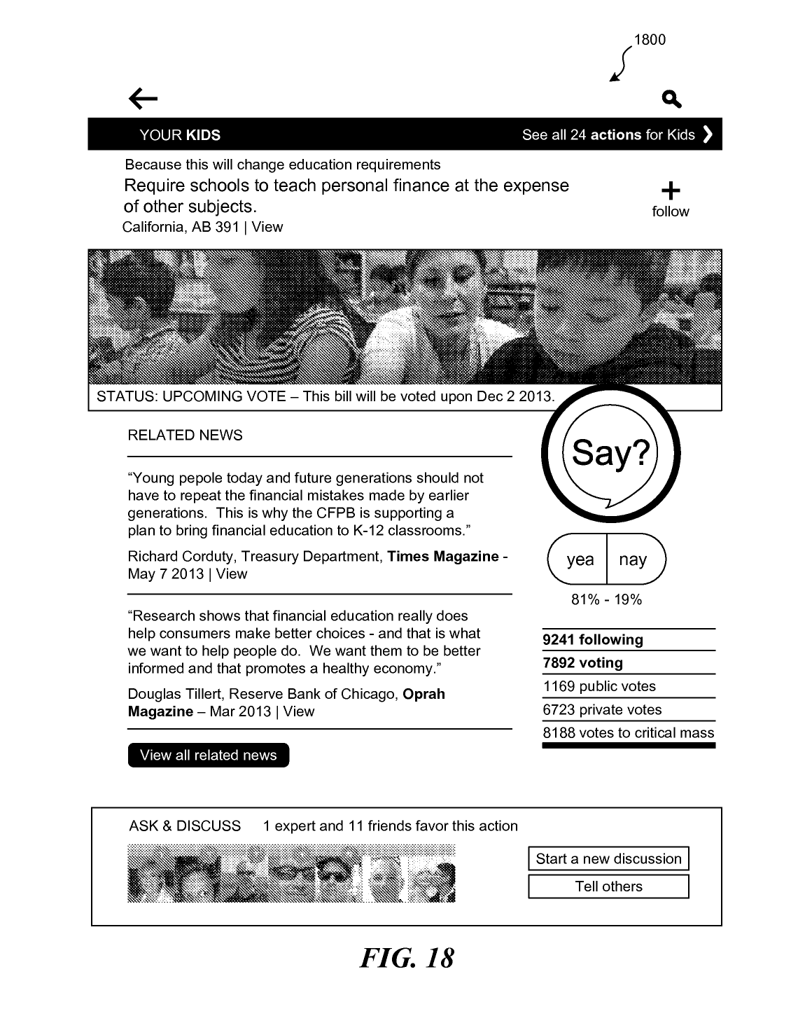

FIG. 17 provides an illustrative example of the personal context page 1700, 900 of the social networking environment 600, which includes the list of the categories into which the user's life has been partitioned into, the identified public content within each of those categories and any votes (i.e. expressed opinion) by the user with respect to the identified public content. FIG. 18 provides an illustrative example on an article identified for the user under the user's “KIDS” category, where the article relates to local schools the user's kids could likely be attending and be impacted by any public actions discussed in the article.

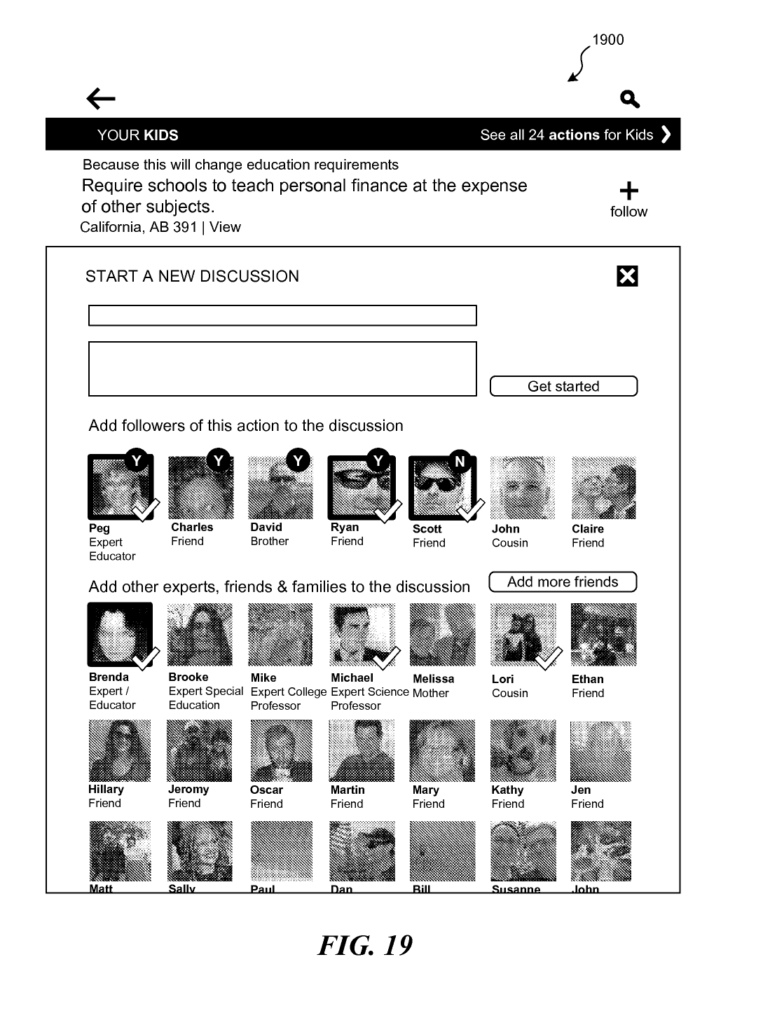

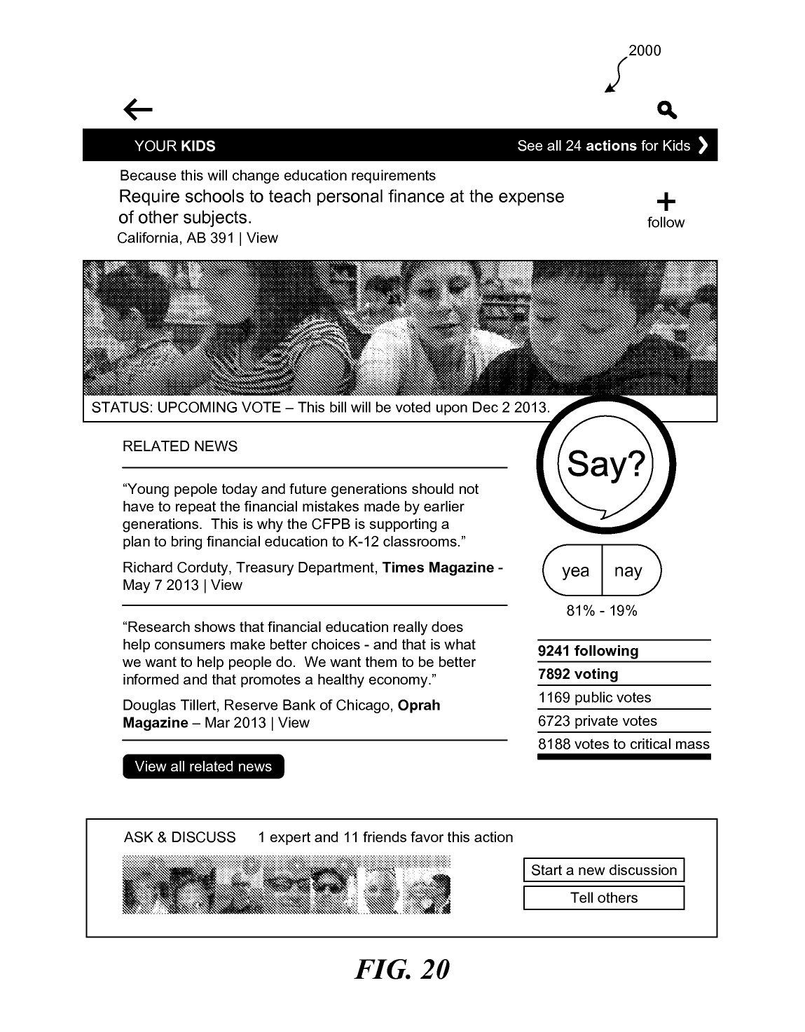

FIG. 19 provides an illustrative example of how the user can initiate a discussion forum/thread 1900 with other users of the social networking environment 600 who may have expressed an opinion on the subject. In embodiments, the disclosed technology allows the user to select a subset of the listed users to form a group from those listed users to initiate a discussion forum/thread. FIG. 20 provides an illustrative example of the displayed article 2000 provided to the user, within the social networking environment 600, when returning from initiating the discussion forum/thread 1900.

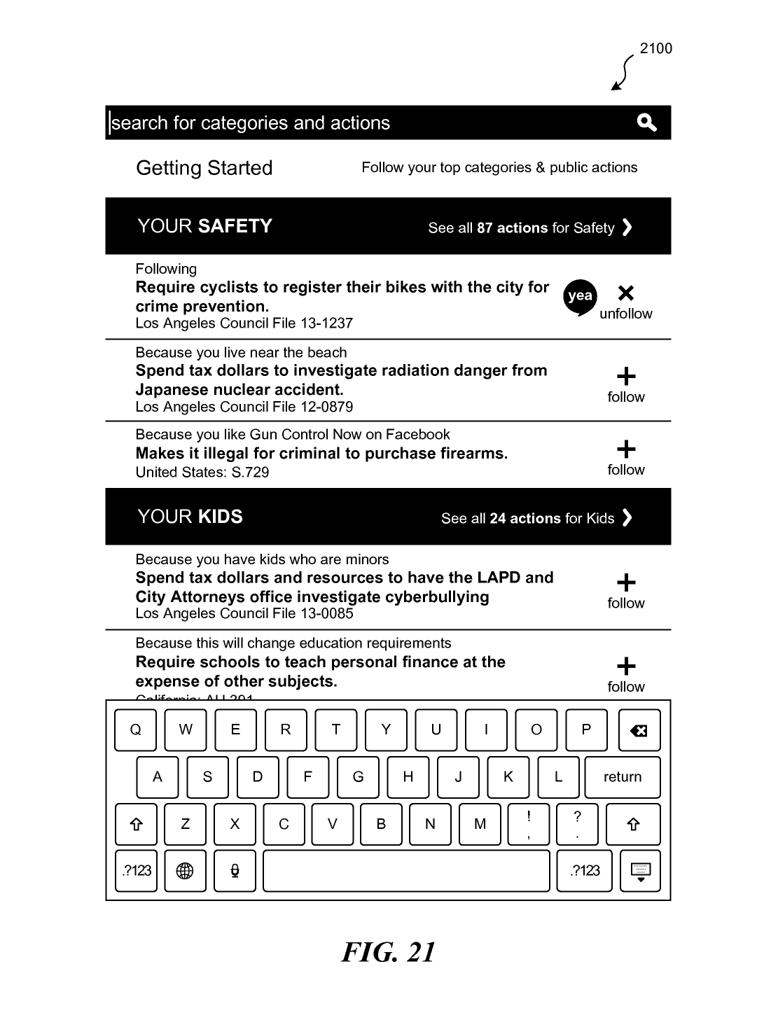

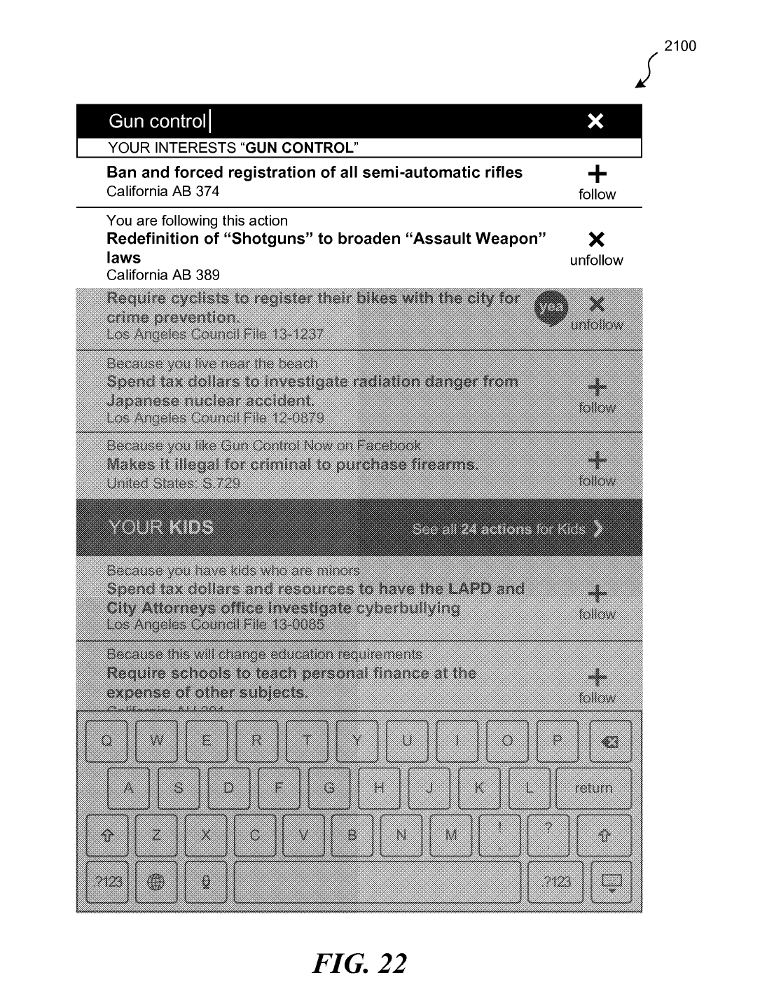

FIG. 21 provides an illustrative example of how the user can perform a search 2100 for interested political actions and other categories within the social networking environment 600. FIG. 22 provides an illustrative example of how the search results 2200 are provided to the user in response to a search performed by the user within the social networking environment 600. In response to a search, in embodiments, the disclosed technology provides the user with results of search of political actions database and search of other actions being followed by the user, which are related to the search terms.

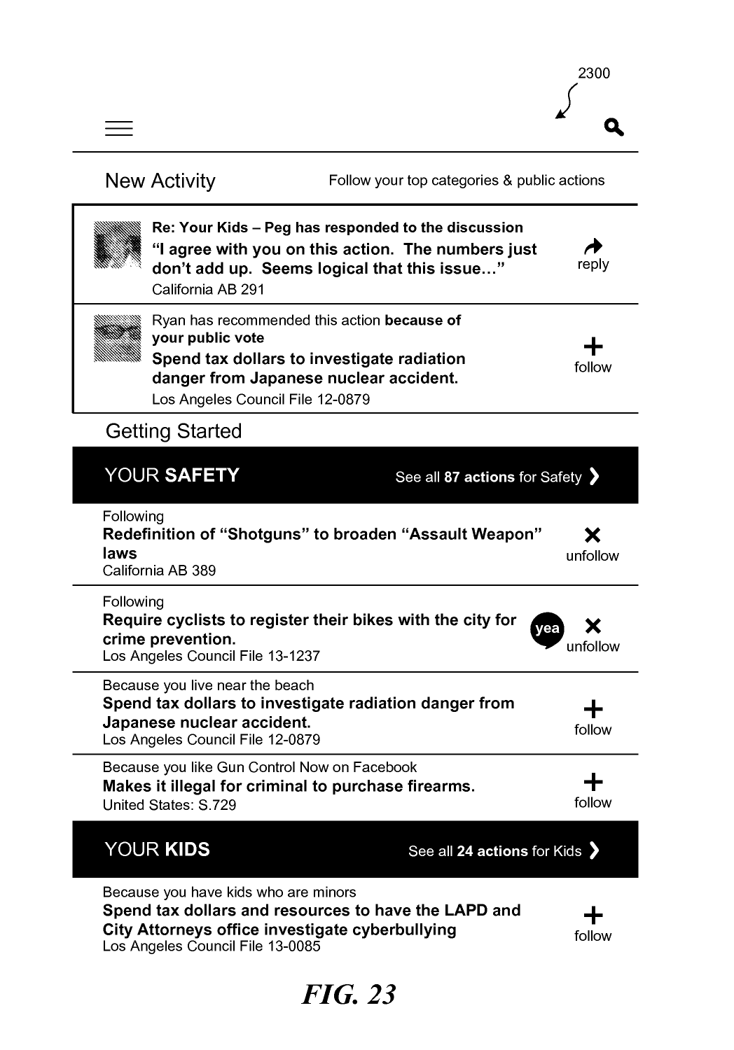

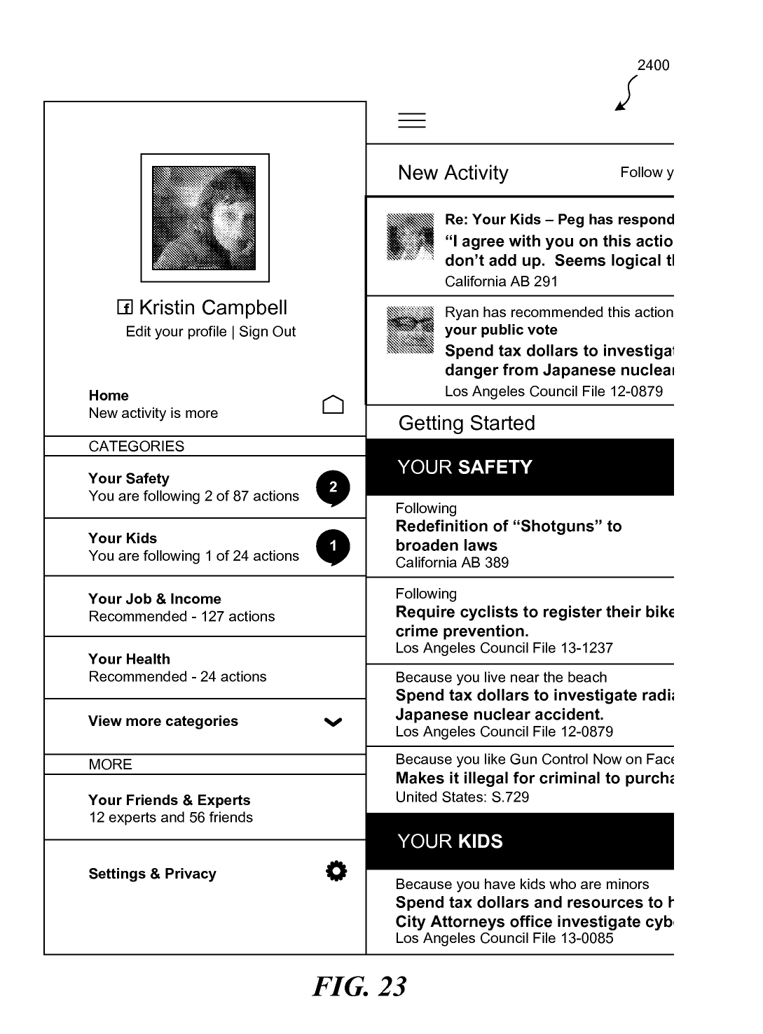

FIG. 23 provides an illustrative example of a new activity summary 2300 that can be provided to the user of the social networking environment 600. The new activity summary can include statistic updates of political actions being followed by the user, comments posted by users of actions being followed by the user, etc. FIG. 24 provides an illustrative example of a summarized new activity summary 2400 that can be provided to the user of the social networking environment 600. The summarized new activity summary can highlight which categories of the user's personal categories have received any new activity, etc.

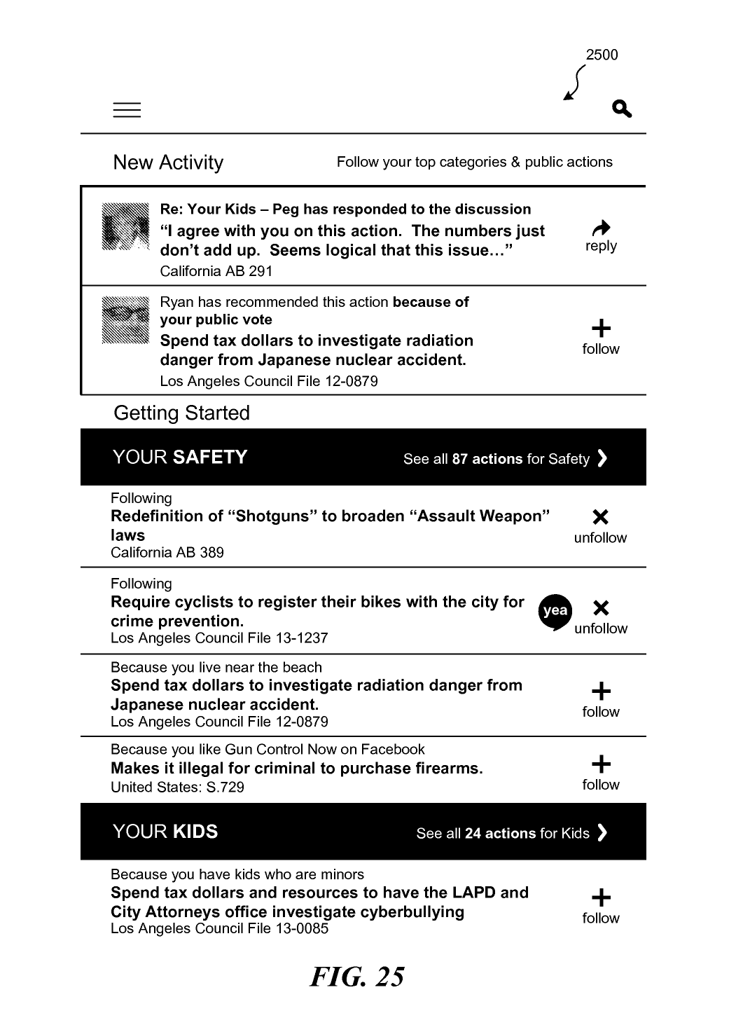

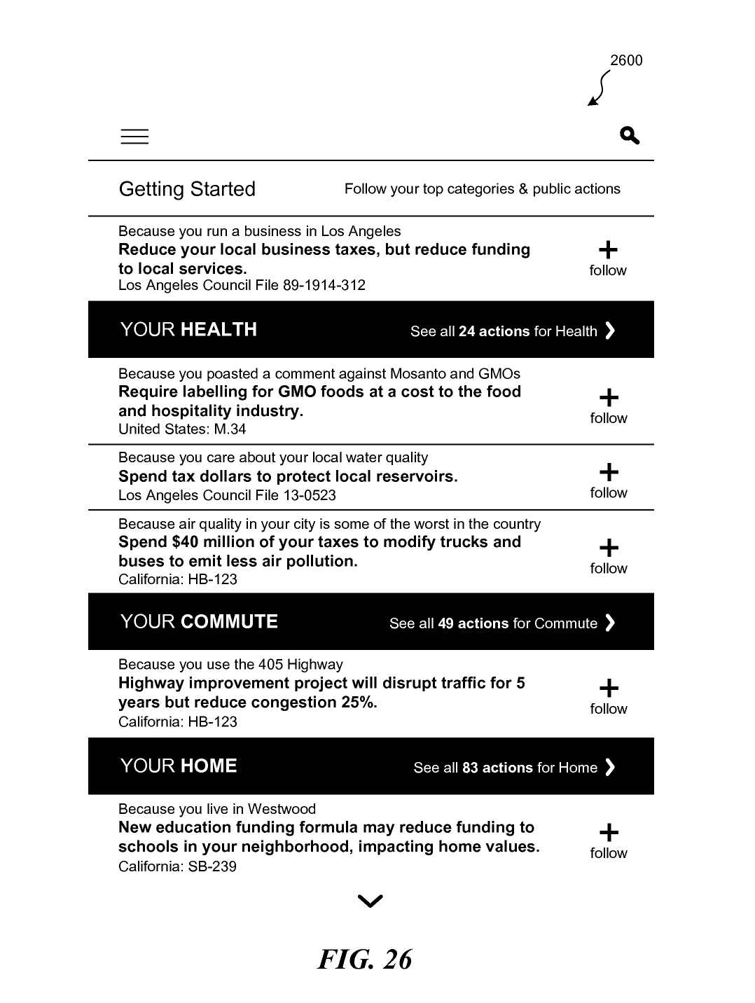

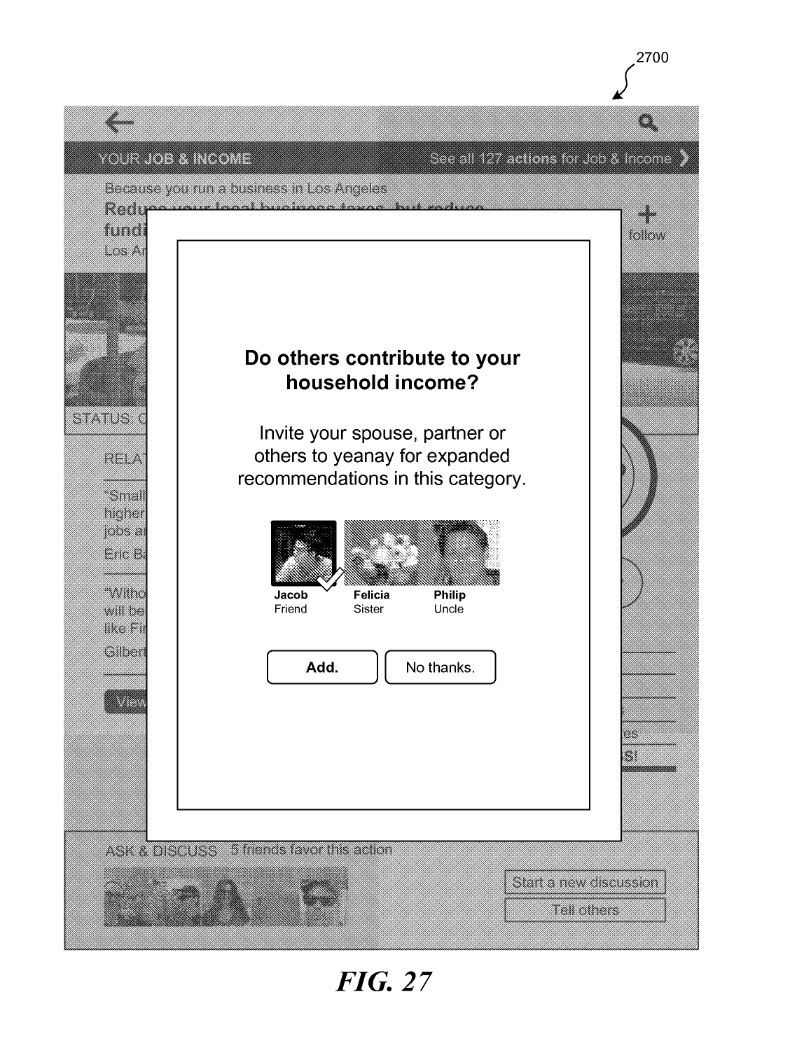

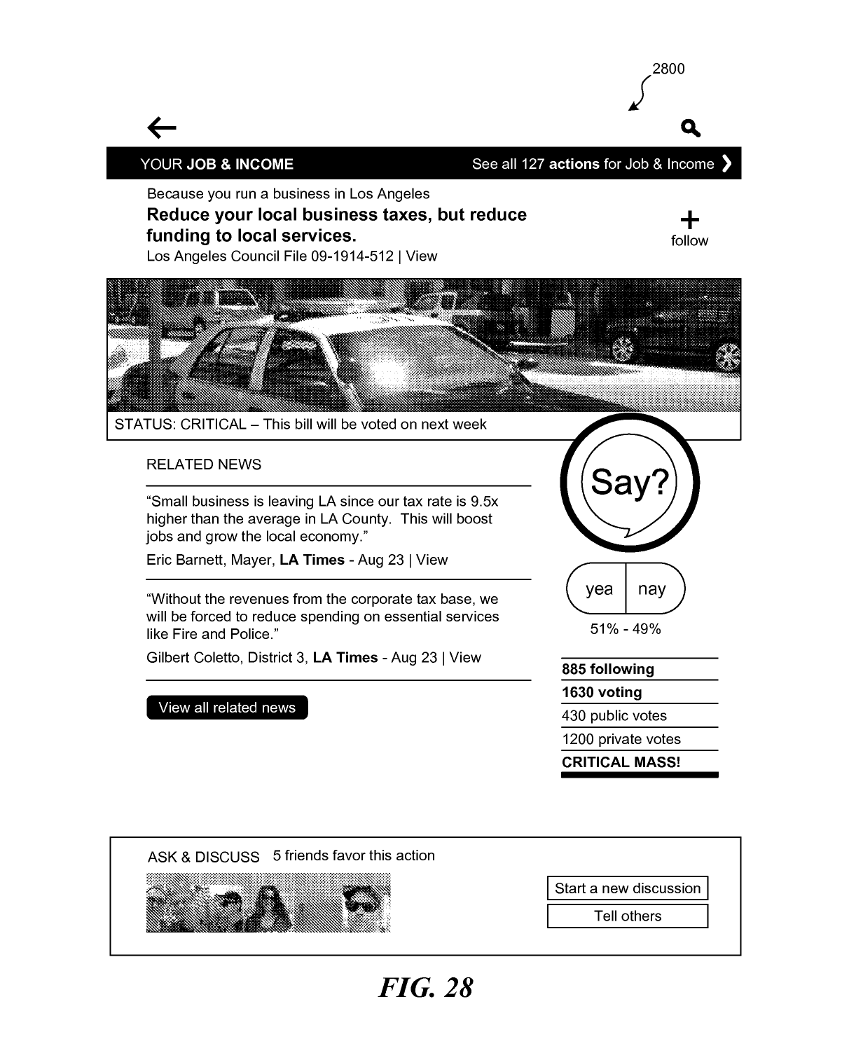

FIG. 25 provides an illustrative example of the personal category list 2500 provided to the user, within the social networking environment 600, when returning from reviewing the summarized new activity summary 2400. FIG. 26 provides an illustrative example of the additional personal categories 2600 that are provided to the user within the social networking environment 600. FIG. 27 provides an illustrative example of how the relevant political content provided to the user within the social networking environment 600 can be improved. In embodiments, the disclosed technology prompts the user to provide identification information 2700 of the user's spouse, which can then be utilized to create to analyze the spouse's profile and provide relevant content that impacts the user's family (which now includes the spouse).

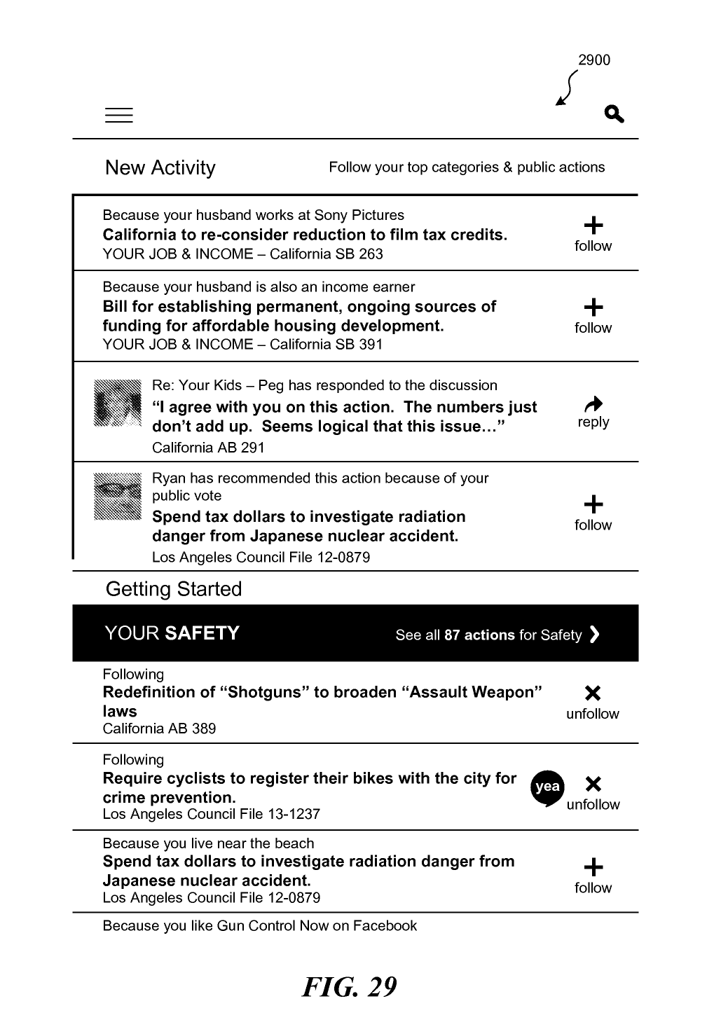

FIG. 28 provides an illustrative example of a displayed article 2800, provided to the user within the social networking environment 600, when the user clicks on an article provided within their “JOBS & INCOME” personal category. FIG. 29 provides an illustrative example of an updated new activity summary 2300 that now provides updates related to the user's spouse (upon identifying the spouse by the user) in the social networking environment 600.

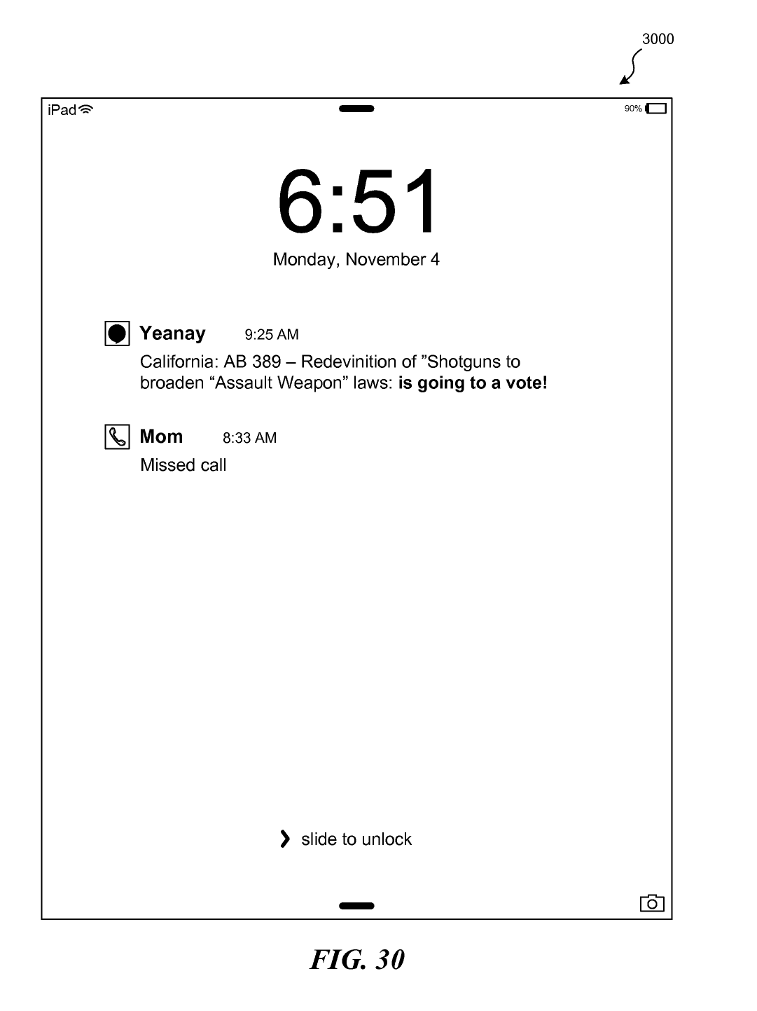

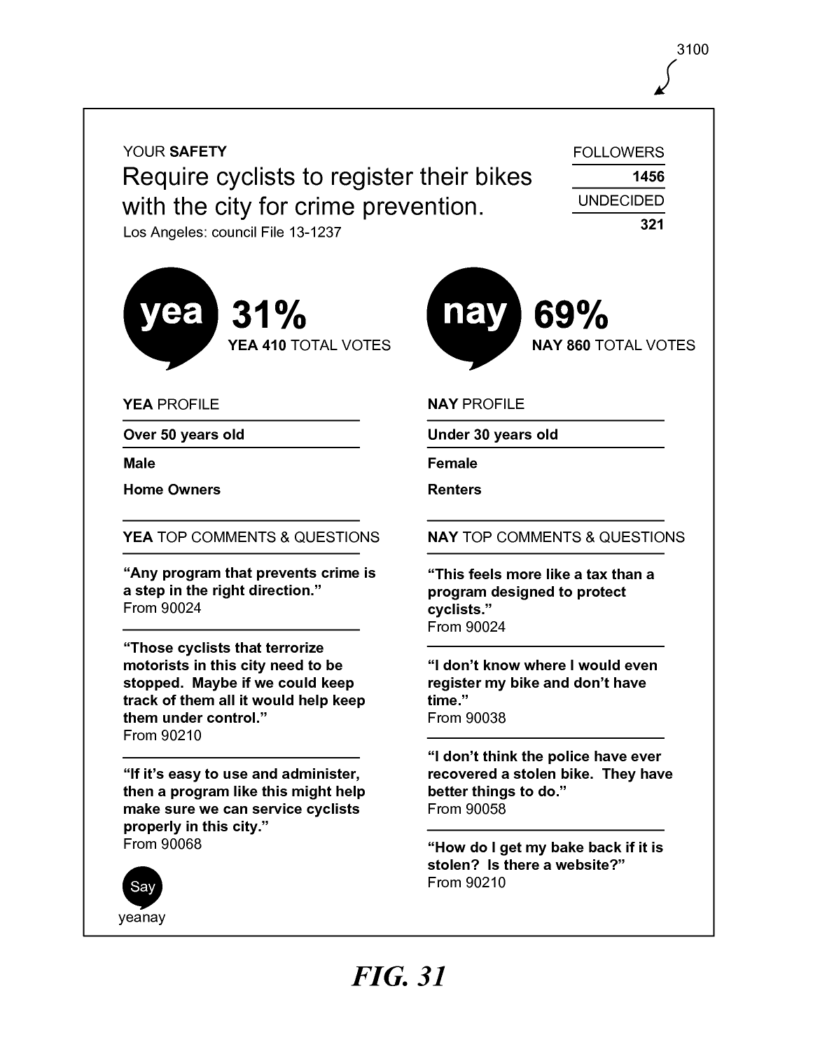

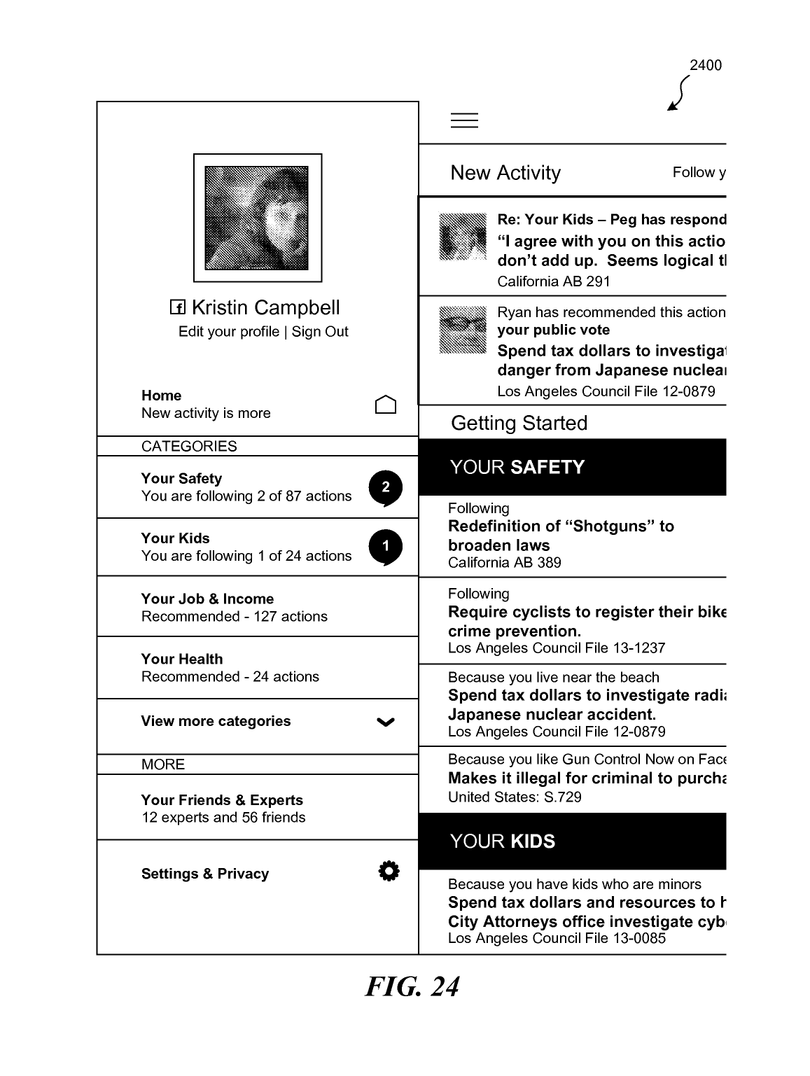

FIG. 30 provides an illustrative example of an alert 3000 provided to the user of the social networking environment 600 through any of their computing devices, e.g., smart phones, tablets, etc. In embodiments, the alerts can be configured by the user or be sent according to a default configuration, where the alert is sent to the user when an event associated with the alert reaches a predefined milestone. FIG. 31 provides an illustrative example of a summary of a political action 3100 relevant to the user. In embodiments, the summary could include any statistics associated with the action (e.g., yea/nay vote split), demography of the users supporting a given position, comments provided in support and against the political action, etc.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

The above description and drawings are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the technology.

What is claimed is:

1. A computer implemented method for presenting targeted content associated with public decisions, the method comprising:
receiving, via a network, public content and multimedia coverage content from one or more third party sources;
wherein the public content includes publicly available and network accessible digital content associated with public decisions, and wherein, the multimedia coverage content includes network accessible digital multimedia content associated with media coverage of public decisions;
analyzing, by one or more processors, the public content and multimedia coverage content, including metadata associated with both the public content and multimedia coverage content;
identifying, by one or more processors, based on the analysis, matches between public content and multimedia coverage content;
associating, by one or more processors, matched public content and multimedia coverage content to a specific public decision;
analyzing, by one or more processors, the matched public content and multimedia coverage content associated with the specific public decision to determine a relevancy of the specific public decision to one or more predefined demographic and geographic categories;
assigning, by one or more processors, a general relevancy score for the specific public decision in each of the predefined demographic and geographic categories based on the analysis;
comparing, by one or more processors, the general relevancy scores of the specific public decision to a user profile including data related to one or more of the predefined demographic and geographic categories to determine a specific relevancy score of the specific public decision to the user profile; and
presenting, via a display of a user device, the specific public decision including at least some of the associated public content and multimedia coverage content, if the specific relevancy score meets a threshold criteria.

2. A computer-implemented method for presenting targeted content associated with public decisions, the method comprising:
identifying, by one or more processors, one or more public decisions as relevant to a user based on at least information included in a user profile;
wherein, each of the one or more identified public decisions is associated with content accessible via a network;
presenting, via a display of a user device, a user interface including a list of the one or more identified public decisions; and
presenting, via the user interface, the content associated with the one or more identified public decisions.

3. The method of claim 2, wherein the content includes at least, a media article associated with the public decision, public documents associated with the public decision and information on key decision makers and influencers associated with the public decision.

4. The method of claim 2, wherein the public decision is related to one or more of the following: government, politics, business, sports, and entertainment.

5. The method of claim 2, wherein the list of the one or more identified public decisions is organized into one or more predefined demographic categories based on at least information included in the user profile.

6. The method of claim 2, wherein the list of the one or more identified public decisions is organized into one or more predefined geographic categories based on at least information included in the user profile.

7. The method of claim 2, further comprising:
presenting, via the user interface, a profiler question;
receiving, via the network, a response to the profiler question; and
updating the user profile based on the response to the profiler question.

8. The method of claim 7, further comprising:
identifying, by one or more processors, a specific public decision as relevant to the user based on the response to the profiler question; and
presenting, via the user interface, the specific public decision including associated content.

9. The method of claim 2, further comprising:
presenting, via the user interface, an option to vote on a position associated with at least one of the one or more public decisions.

10. The method of claim 2, further comprising:
receiving, via the network, a vote by a first user indicating a position on a specific public decision;
identifying, by one or more processors, a second user that has indicated a same or similar position on the specific public decision; and
presenting to the first user, via the user interface, information associated with the second user and an option to connect with the second user.

11. The method of claim 10, further comprising:
restricting access by the first user to information about the second user that is unrelated to the specific public decision.

12. The method of claim 2, further comprising:
generating or updating, by one or more processors, the user profile based on data contained in one or more third-party social network databases.

13. The method of claim 2, further comprising:
receiving, via the network, content from one or more third-party sources; and
analyzing, by one or more processors, the content to identify one or more public decisions associated with the content;
wherein the analysis includes analyzing metadata associated with the content.

14. The method of claim 2, wherein the identifying the one or more public decisions as relevant includes:
transmitting, via a network, a plurality of queries to one or more databases for public decisions that match with the user profile; and
receiving, via the network, a plurality of initial match public decisions that meet a threshold criteria, based on a comparison between content associated with the public decisions and data associated with the user profile.

15. The method of claim 14, wherein threshold criteria includes one or more selected from the following: the public decision is mapped to a profiler question of which an affirmative response has been received, the public decision has not already been included in the list of identified public decisions presented via the user interface, the public decision is associated with a geographical area that coincides with a geographical area associated with the user profile, and the public decision is associated with content metadata that indicates a relevancy to a predefined demographic and user profile is characteristics of the same predefined demographic.

16. The method of claim 15, wherein the identifying the one or more public decisions as relevant further includes:
comparing the plurality of initial match public decisions; and
if the plurality of initial match public decisions are not the same, applying a weighted randomizer to select at least one matching public decision as relevant.

17. The method of claim 16, wherein applying the weighted randomizer includes:
assigning a trending factor and a temporal factor to each of the plurality of initial match public decisions;
wherein, the trending factor is based on a number of received votes associated with a given public decision;
wherein, the temporal factor is based on a based on a period of time elapsed since the given public decision or content associated with the given public decision was submitted;
wherein, the trending factor and temporal factor are associated with a probability of selection; and
selecting the at least one matching public decision from the plurality of initial match public decisions, taking into consideration their respectively assigned trending and temporal factors and the associated probabilities of selection.

18. A system for presenting targeted content associated with public decisions, the system comprising:
one or more processors;
one or more memory units coupled to the one or more processors, the one or more memory units having stored thereon instructions, which when executed by the one or more processors, cause the system to:
identify one or more public decisions as relevant to a user based on at least information included in a user profile;
wherein, each of the one or more identified public decisions is associated with content accessible via a network;
present, via a display of a user device, a user interface including a list of the one or more identified public decisions; and
present, via the user interface, the content associated with the one or more identified public decisions.

19. The system of claim 18, wherein the one or more memory units have further instructions stored thereon, which when executed by the one or more processors, cause the system to further:
present, via the user interface, a profiler question;
receive, via the network, a response to the profiler question;
identify a specific public decision as relevant to the user based on the response to the profiler question; and
present, via the user interface, the specific public decision including content associated with the specific public decision.

20. The system of claim 18, wherein the one or more memory units have further instructions stored thereon, which when executed by the one or more processors, cause the system to further:
present, via the user interface, an option to vote on a position associated with at least one of the one or more public decisions.

21. The system of claim 18, wherein the one or more memory units have further instructions stored thereon, which when executed by the one or more processors, cause the system to further:
receive, via the network, a vote by a first user indicating a position on a specific public decision;
identify a second user that has indicated a same or similar position on the specific public decision; and
present to the first user, via the user interface, information associated with the second user and an option to connect with the second user.

22. The system of claim 18, wherein the one or more memory units have further instructions stored thereon, which when executed by the one or more processors, cause the system to further:
receive, via the network, content from one or more third-party sources; and
analyze the content to identify one or more public decisions associated with the content;
wherein the analysis includes analyzing metadata associated with the content.

23. The system of claim 18, wherein the one or more memory units have further instructions stored thereon, which when executed by the one or more processors, cause the system to further:
transmit, via a network, a plurality of queries to one or more databases for public decisions that match with the user profile; and
receive, via the network, in response to the transmitting, a plurality of initial match public decisions that meet a threshold criteria, based on a comparison between content associated with the public decisions and data associated with the user profile.

24. The system of claim 23, wherein the one or more memory units have further instructions stored thereon, which when executed by the one or more processors, cause the system to further:
compare the plurality of initial match public decisions; and
if the plurality of initial match public decisions are not the same:
assign a trending factor and a temporal factor to each of the plurality of initial match public decisions;
wherein, the trending factor is based on a number of received votes associated with a given public decision;
wherein, the temporal factor is based on a based on a period of time elapsed since the given public decision or content associated with the given public decision was submitted;
wherein, the trending factor and temporal factor are associated with a probability of selection; and
select the at least one matching public decision from the plurality of initial match public decisions, taking into consideration their respectively assigned trending and temporal factors and the associated probabilities of selection.
